(19) United States
(12) Patent Application Publication
(10) Pub. No.: US 2009/0200234 A1
(43) Pub. Date: Aug. 13, 2009

(54) METHODS FOR CLEANING SURFACES WITH ACTIVATED OXYGEN

(75) Inventors: Paul F. Schacht, Oakdale, MN (US); Peter J. Fernholz, Burnsville, MN (US); Nathan D. Peitersen, Apple Valley, MN (US); Joseph P. Curran, Forest Lake, MN (US); Ralf Krack, Dusseldorf (DE); Mark R. Altier, Mendota Heights, MN (US); Gina F. Danielson, St. Paul, MN (US); Victor F. Man, St. Paul, MN (US); Joshua P. Magnuson, St. Paul, MN (US); John W. Bolduc, Woodbury, MN (US); Keith G. Lascotte, Maplewood, MN (US); Jeffrey S. Hutchison, Minneapolis, MN (US); Steven E. Lentsch, St. Paul, MN (US)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 12/369,447

(22) Filed: Feb. 11, 2009

Related U.S. Application Data
(60) Provisional application No. 61/027,605, filed on Feb. 11, 2008.

(51) Int. Cl. B01D 65/06

(52) U.S. Cl. 210/636

(57) ABSTRACT

The present invention provides methods for cleaning surfaces that are sensitive to high temperatures and/or that have pH limitations. Exemplary surfaces to be cleaned using the methods of the present invention include membranes. The methods of the present invention include applying an active oxygen use solution including an active oxygen source to the surface. An activator complex and an alkaline override use solution are applied to the surface, either in combination, or in a stepwise manner, before, after or simultaneously with the active oxygen use solution.

### CROSS REFERENCE TO RELATED APPLICATIONS

The present application claims priority to U.S. Provisional Patent Application No. 61/027,605, entitled “Methods for Cleaning Surfaces with Activated Oxygen,” filed on Feb. 11, 2008. The entire contents of this patent application are hereby expressly incorporated herein by reference including, without limitation, the specification, claims, and abstract, as well as any figures, tables, or drawings thereof.

### FIELD OF INVENTION

The present disclosure relates to methods for cleaning surfaces that are sensitive to high temperatures and/or that have pH limitations, i.e., surfaces that can tolerate only a limited range of pH.

### BACKGROUND

In many industrial applications, such as the manufacture of foods and beverages, hard surfaces become contaminated with carbohydrate, proteinaceous, hardness soils and other soils. Similarly, other materials such as proteins, enzymes, fats and oils can also form hard to remove soil and residues. The removal of such soils presents a significant challenge.

Conventional cleaning techniques include the use of high heat and/or extreme pH, i.e., very high alkalinity use solutions, or very low pH acidic use solutions. However, many surfaces cannot tolerate such conditions. For example, membranes used in the manufacture of foods and beverages often have specific limitations with respect to the temperature and pH at which they can be operated and cleaned due to the material from which they are constructed.

A common filtration membrane used in the dairy industry is a polysulfone or polymeric ultra filtration membrane (UF membrane). UF membranes are often used for processing whey protein concentrate, whey protein isolate, and cheese whey. In non-dairy industrial applications, UF membranes are used in making flexographic ink.

Filtration membranes have a tendency to foul during processing. Fouling manifests itself as a decline in flux with time of operation. Flux decline typically occurs when all operating parameters, such as pressure, flow rate, temperature, and feed concentration are kept constant. In general, membrane fouling is a complicated process and is believed to be due to a number of factors including electrostatic attraction, hydrophobic and hydrophilic interactions, the deposition and accumulation of feed components, e.g., suspended particulates, impermeable dissolved solutes, and even normally permeable solutes, on the membrane surface and/or within the pores of the membrane. It is expected that almost all feed components will foul membranes to a certain extent. Fouling components and deposits can include inorganic salts, particulates, microbials and organics.

Filtration membranes typically require periodic cleaning to allow for successful industrial application within separation facilities such as those found in the food, dairy, and beverage industries. The filtration membranes can be cleaned by removing foreign material from the surface and body of the membrane and associated equipment. The cleaning procedure for filtration membranes can involve a “clean-in-place” (CIP) process where cleaning agents are circulated over the membrane to wet, dissolve and/or rinse away foreign materials from the membrane. Various parameters that can be manipulated for cleaning typically include time, temperature, mechanical energy, chemical composition, chemical concentration, soil type, water type, and hydraulic design.

Chemical energy in the form of detergents and cleaners can be used to solubilize or disperse the foulant or soil. Thermal energy in the form of heat can be used to help the action of the chemical cleaners. In general, the greater the temperature of the cleaning solution, the more effective it is as a cleaning treatment, although most membrane materials have temperature limitations due to the material of construction. Many membranes additionally have chemical limitations. Mechanical energy in the form of high velocity flow also contributes to the successful cleaning of membrane systems.

In general, the frequency of cleaning and type of chemical treatment performed on the membrane has been found to affect the operating life of a membrane. It is thought that the operating life of a membrane is decreased as a result of chemical degradation of the membrane over time. Various membranes are provided having temperature, pH, and chemical restrictions to minimize degradation of the membrane material. For example, many polyamide reverse osmosis membranes have chlorine restrictions because chlorine can have a tendency to damage the membrane. Cleaning and sanitizing filtration membranes is desirable in order to comply with laws and regulations that may require cleaning in certain applications (e.g., the food and biotechnology industries), reduce microorganisms to prevent contamination of the product streams, and optimize the process by restoring flux.

Similar pH and temperature limitations during operation and cleaning exist for other surfaces and equipment as well, for example, certain medical devices. Thus, a need exists for effective methods for removing soils from surfaces which are sensitive to temperature and/or pH, as well as to conventional ingredients in cleaning regimens, e.g., chlorine.

### SUMMARY OF INVENTION

The present invention provides methods for cleaning and removing soils from surfaces that have temperature and/or pH limitations. The methods of the present invention are suitable for use on any surface sensitive to temperature and/or pH including, but not limited to, membranes, and medical devices. Active oxygen use solutions including an active oxygen source are applied to the surface to be cleaned. When contacted with an activator complex at an alkaline pH, oxygen gas is generated on and in the soil on the surface, enhancing and facilitating soil removal.

Accordingly, in some aspects, the present invention provides a method for removing soil from a membrane. The method comprises applying an acidic active oxygen use solution to the membrane for an amount of time sufficient to penetrate the soil on the membrane. The acidic active oxygen solution comprises an active oxygen source. The method further comprises applying an alkaline override solution comprising an activator complex and a source of alkalinity. There is no rinse step required between the application of the acidic active oxygen use solution and the application of the override solution.

In some aspects, the present invention provides a method for removing soil from a membrane comprising applying an acidic active oxygen use solution to the membrane for an amount of time sufficient to penetrate the soil on the membrane, said acidic active oxygen use solution comprising an active oxygen source. The method further comprises applying an activator complex, and in a separate step, applying an alkaline override solution. In some embodiments, there is no rinse step between the application of the acidic active oxygen use solution, the application of the activator complex, and the application of the alkaline override solution.

In some aspects, the present invention provides a method for removing soil from a membrane comprising applying a first acidic active oxygen use solution, a first activator complex, and a first alkaline override use solution to the surface simultaneously. The membrane is then rinsed, and a second acidic active oxygen use solution is applied to the membrane. A second activator complex and a second alkaline override solution are also applied to the membrane in a stepwise manner. In some embodiments, there is no rinse step between the application of the second acidic active oxygen use solution, the application of the second activator complex, and the application of the second alkaline override solution.

In other aspects, the present invention provides a method for removing soil from a surface comprising contacting the surface with an activated cleaning solution, wherein the activated cleaning solution is prepared by contacting a solid composition comprising an active oxygen source with an aqueous solution comprising an activator complex. Dissolution of the solid composition is initiated upon contact with the aqueous solution forming an activated cleaning solution.

Alternatively, in some aspects the present invention provides methods for removing soils from a surface comprising contacting a solid activator complex with an acidic active oxygen use solution comprising an active oxygen source to form an activated cleaning solution. The activated cleaning solution is then applied to the surface. An alkaline override solution is then applied to the surface. There is no rinse step between the application of the activated cleaning solution, and the application of the alkaline override solution.

The details of one or more embodiments of the invention are set forth in the accompanying drawings and the description below. Other aspects of the invention will be apparent from the description and drawings, and from the claims.

### BRIEF DESCRIPTION OF DRAWINGS

FIG. 1 is a graph illustrating the dead end water flux data throughout a cleaning cycle as described in Example 1.

FIG. 2 is a graph illustrating the wash flux data over the course of washes #1 and #2 as described in Example 1.

FIG. 3 is a graph illustrating the dead end water data of a dirty membrane compared to the dead end flux data of the membrane at the end of washes #1 and #2 as described in Example 1.

FIG. 4 is a graph illustrating the wash flux data over the course of washes #1 and #2 as described in Example 1.

FIG. 5 is a graph illustrating the dead end flux data at the end of washes #1 and #2 as described in Example 1.

FIG. 6 is a graph illustrating the wash flux data at the end of washes #1 and #2 as described in Example 1.

FIG. 7 is a graph illustrating the degradation of active oxygen in an active oxygen use solution when activated by varying concentrations of potassium iodide or molybdate.

FIG. 8 is a graph illustrating the degradation of active oxygen in an active oxygen use solution when activated by varying concentrations of molybdate.

FIG. 9 is a graph illustrating the degradation of active oxygen in an active oxygen use solution when activated by catalase enzyme, cobalt, molybdate or copper.

FIG. 10 is a graph illustrating the degradation of active oxygen in an active oxygen use solution when activated by varying concentrations of copper, iron, or molybdate.

FIG. 11 is a graph illustrating the degradation of active oxygen in an active oxygen use solution when activated by molybdate at varying temperatures.

FIG. 12 is a graph illustrating the degradation of active oxygen in an active oxygen use solution when activated by molybdate at pH 2 and pH 6.

FIG. 13 is a graph illustrating the degradation of active oxygen in an active oxygen use solution when activated by molybdate or iron.

FIG. 14 is a graph illustrating the results of a cleaning test comparing 50 ppm iron and 50 ppm molybdate at pH 2 and pH 10.

### DETAILED DESCRIPTION OF INVENTION

In some aspects, the present invention relates to methods and compositions for removing soils from surfaces that are sensitive to heat, and/or that have pH limitations. An activator complex is provided to act as a catalyst for oxygen generation during the cleaning of the surface. Use of the activator complex provides for enhanced cleaning and soil removal without the use of high temperatures and while staying within the pH limitations of the surface to be cleaned.

In some aspects, the method of the present invention includes applying an active oxygen use solution to a surface for an amount of time sufficient to penetrate the soil on the surface. The method further includes the step of applying an alkaline override solution without first rinsing the surface to be cleaned, i.e., there is no rinse step between the application of the active oxygen use solution and the alkaline override solution. The alkaline override solution can be applied to the surface at any time during the cleaning process, e.g., before, during, or after the active oxygen solution has been applied.

Likewise, the activator complex can be applied to the surface at any time during the cleaning process. For example, in some embodiments the activator complex is included in the alkaline override solution. In other embodiments, the activator complex is applied to the surface to be cleaned after the active oxygen use solution has been applied, but before the alkaline override use solution is applied, wherein there is no rinse step between any of the aforementioned application steps. In yet other embodiments, the activator complex is applied after both an active oxygen use solution and an alkaline override use solution have been applied to the surface. In still yet other embodiments, the activator complex is applied to the surface prior to the application of the active oxygen and the alkaline override use solutions. In still yet other embodiments, the active oxygen use solution, activator complex, and alkaline override use solution are applied to the surface at the same time. Any order of application of activator complex (either alone or as part of the active oxygen solution or alkaline override use solution), active oxygen use solution, and alkaline override use solution that results in effective soil removal can be used with the methods of the present invention.

So that the invention maybe more readily understood, certain terms are first defined.

As used herein, “weight percent,” “wt-%,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt-%,” etc.

As used herein, the term “about” refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

As used herein, the term “cleaning” refers to a method used to facilitate or aid in soil removal, bleaching, microbial population reduction, and any combination thereof.

### Active Oxygen Use Solutions

In some aspects, the present invention provides a method for removing soil from a surface that is sensitive to heat and/or that has pH limitations including applying an active oxygen use solution to a surface to facilitate soil removal from the surface. As used herein, the term “active oxygen use solution,” or “active oxygen solution,” refers to any solution that includes an active oxygen source suitable for use with the methods of the present invention. The active oxygen use solution selected is dependent on a variety of factors, including, but not limited to, the type of soil to be removed, and the surface from which the soil is removed. In some aspects, the active oxygen use solution is an acidic active oxygen use solution.

In some embodiments the active oxygen use solution includes about 0.01% to about 10% active ingredients. As used herein the term “active ingredients” refers to the non-inert ingredients included in the active oxygen use solution that facilitate the cleaning of the selected surface. Active ingredients for use with the methods of the present invention include, but are not limited to any active oxygen source, activator complex, alkaline/base, acid, surfactant, and/or builder. In most embodiments, water is the remainder of the solution.

In some embodiments, the active oxygen use solution has about 0.1% active ingredients to about 1% active ingredients. It is to be understood that all ranges and values between these ranges and values are encompassed by the present invention.

In some embodiments, the active oxygen use solution is acidic. The pH of the acidic active oxygen use solution is formulated to provide adequate mineral removal. In some embodiments, the pH of the acidic active oxygen use solution will be about 1 to about 5. In some embodiments, the pH of the acidic active oxygen use solution will be about 2. The acidity of the active oxygen use solution will depend on the surface being cleaned, as well as the type and amount of soil present on the surface. In some embodiments, the acidic active oxygen use solution has a pH of about 2 and is used to clean a membrane.

Active Oxygen Source

In some embodiments, the active oxygen use solution includes an active oxygen source. As used herein, the term “active oxygen source,” refers to any composition capable of generating oxygen gas in situ on and in a soil, as well as in solution. In some embodiments, the active oxygen source is a compound capable of providing oxygen gas in situ on and in the soil upon contact with an activator complex. The compound can be organic, or inorganic. Preferred active oxygen sources release active oxygen gas in aqueous solutions, as well as on and in the soils contacted with the active oxygen source.

Exemplary active oxygen sources for use in the methods of the present invention include, but are not limited to, peroxygen compounds, chlorites, bromine, bromates, bromine monochloride, iodine monochloride, iodates, permanganates, nitrates, nitric acid, borates, perborates, and gaseous oxidants such as ozone, oxygen, chlorine dioxide, chlorine, sulfur dioxide and derivatives thereof. In some embodiments, the active oxygen source does not include a chlorine containing group. Without wishing to be bound by any particular theory, it is thought that reaction of the active oxygen source with the soil creates vigorous mechanical action on and within the soil due to the oxygen gas released. It is thought that this mechanical action enhances removal of the soil beyond that caused by the chemical and bleaching action of the active oxygen source alone.

In some embodiments, the active oxygen use solution includes at least one peroxygen compound as an active oxygen source. Peroxygen compounds, including, but not limited to, peroxides and various percarboxylic acids, including percarbonates, can be used with the methods of the present invention. Peroxycarboxylic (or percarboxylic) acids generally have the formula R(CO₃H)ₙ, where, for example, R is an alkyl, arylalkyl, cycloalkyl, aromatic, or heterocyclic group, and n is one, two, or three, and named by prefixing the parent acid with peroxy. The R group can be saturated or unsaturated as well as substituted or unsubstituted. Medium chain peroxycarboxylic (or percarboxylic) acids can have the formula R(CO₃H)ₙ, where R is a C₅-C₁₁ alkyl group, a C₅-C₁₁ cycloalkyl, a C₅-C₁₁ arylalkyl group, C₅-C₁₁ aryl group, or a C₅-C₁₁ heterocyclic group; and n is one, two, or three. Short chain perfatty acids can have the formula R(CO₃H)ₙ, where R is C₁-C₄ and n is one, two, or three.

Exemplary peroxycarboxylic acids for use with the present invention include, but are not limited to, peroxypentanoic, peroxyhexanoic, peroxyheptanoic, peroxyoctanoic, peroxynonanoic, peroxyisononanoic, peroxydecanoic, peroxyundecanoic, peroxydodecanoic, peroxyascorbic, peroxyadipic, peroxycitric, peroxypimelic, or peroxysuberic acid, and mixtures thereof.

Branched chain peroxycarboxylic acids include peroxyisopentanoic, peroxyisononanoic, peroxyisohexanoic, peroxyisoheptanoic, peroxyisooctanoic, peroxyisonananoic, peroxyisodecanoic, peroxyisoundecanoic, peroxyisododecanoic, peroxyneopentanoic, peroxyneohexanoic, peroxyneoheptanoic, peroxyneooctanoic, peroxyneononanoic, peroxyneodecanoic, peroxyneoundecanoic, peroxyneododecanoic, and mixtures thereof.

Additional exemplary peroxygen compounds for use with the methods of the present invention, include hydrogen peroxide (H₂O₂), peracetic acid, peroctanoic acid, a persulphate, a perborate, or a percarbonate. In some embodiments, the active oxygen use solution includes hydrogen peroxide as an active oxygen source.

In some aspects, the active oxygen use solution includes at least one active oxygen source. In some embodiments, the active oxygen use solution includes at least two, at least three, or at least four active oxygen sources. For example, combinations of active oxygen sources for use with the methods of the present invention can include, but are not limited to, peroxide/peracid combinations, or peracid/peracid combinations. In other embodiments, the active oxygen use solution includes a peroxide/acid or a peracid/acid composition.

The amount of active oxygen source in the active oxygen use solution is dependent on a variety of factors including, for example, the type of surface to be cleaned, and the amount and type of soil present on the surface. In some embodiments, the amount of active oxygen source included in the acidic active oxygen use solution is at least 0.01 wt-% and no greater than about 1 wt-%. Acceptable levels of active oxygen source present are about 0.05 to about 0.25 wt-%; about 0.15 wt-% is a particularly suitable level.

Additional Acidic Components

In some embodiments, the active oxygen use solution further includes an additional acid. Any acid suitable for use on the selected surface can be used with the methods of present invention. For example, the active oxygen use solution can include mineral acids (e.g., phosphoric acid, nitric acid, sulfuric acid) and organic acids (e.g., lactic acid, acetic acid, hydroxyacetic acid, citric acid, glutamic acid, glutaric acid, methane sulfonic acid, acid phosphonates (e.g., HEDP), and gluconic acid). In some embodiments, the ideal additional acidic component provides good chelation once neutralized by the alkaline override use solution, as well as improved shelf-life and stability of the acidic active oxygen use solution.

In some embodiments, the additional acidic component present in the active oxygen use solution includes a carboxylic acid. Generally, carboxylic acids have the formula R—COOH wherein the R may represent any number of different groups including aliphatic groups, alicyclic groups, aromatic groups, heterocyclic groups, all of which may be saturated or unsaturated as well as substituted or unsubstituted. Carboxylic acids for use with the methods of the present invention may include those having one, two, three, or more carboxyl groups.

Carboxylic acids for use in an acidic active oxygen of the present invention include, for example, formic acid, acetic acid, propionic acid, butyric acid, valeric acid, caporic acid, enanthic acid, caprylic acid, pelargonic acid, capric acid, lauric acid, stearic acid, and mixtures thereof.

### Activator Complex

In some aspects, the present invention provides a method for cleaning a surface including applying an activator complex to a surface. As used herein the term “activator complex” or “activation complex” refers to a composition capable of reacting with an active oxygen source to enhance production of oxygen gas in situ on and in the soil, and/or in solution. Activator complexes for use in the present invention include, but are not limited to, transition metal complexes, ethanolamines, carbonates and bicarbonates, iodide salts, hypochlorite salts, and catalase enzymes. Additional activator complexes for use with the present invention include, for example, bisulfites, and thiosulfate. An activator complex for use with the present invention can also include non compositional based sources, for example, UV light. The activator complex, or complexes, selected is dependent on a variety of factors including, for example, the active oxygen use solution selected, the surface to be cleaned, and the amount and type of soil to be removed.

In some embodiments, the activator complex includes a metal. Metals for use in the present invention include, for example, lead, and tin. The metal selected is capable of activating the active oxygen source in order to facilitate oxygen generation without the use of high temperatures, i.e., greater than about 125° F., and/or high alkalinity, i.e., a solution pH greater than about 12. In some embodiments, the activator complex includes a transition metal complex. As used herein the term “transition metal complex” refers to a composition including a transition metal, i.e., any element contained within the d-block on the periodic table, i.e., groups 3 through 12 on the periodic table. Exemplary transition metals suitable for use in the methods of the present invention include, but are not limited to, manganese, molybdenum, chromium, copper, iron, cobalt and mixtures and derivatives thereof. In some embodiments, the metal included in the activator complex is not iron.

In other embodiments, the activator complex includes a composition containing a halogen. Exemplary halogens suitable for use in an activator complex of the present invention include fluorine, chlorine, bromine, iodine, and astatine.

The activator complex can be present in any form suitable for use with the methods of the present invention. For example, in some embodiments the activator complex is included as part of an aqueous solution applied to the surface, e.g., as part of the active oxygen or alkaline override use solution, or as a separate aqueous solution. The activator complex can also be used in the methods of the present invention in the form of a solid. For example, in some embodiments, the activator complex includes a solid block of sodium molybdate. A solution, e.g., an active oxygen use solution including an active oxygen source, can be run over the block. As the solution washes over the block, the sodium molybdate in the block activates the active oxygen source in the solution. The resulting activated solution can then be used to clean the selected surface. For example, the resulting solution can be used in a CIP process to clean a membrane. Other solid forms suitable for use with the methods of the present invention include, but are not limited to, packed column catalysts, immobilized catalases, and inline metallic catalysts or inline UV probes.

Without wishing to be bound by any particular theory, it is thought that the activator complex for use with the methods of the present invention facilities and enhances the ability to clean surfaces that are sensitive to heat and/or that have pH limitations. That is, the use of an activator complex allows for oxygen gas production on and in the soil to be removed without the use of high heat, and/or high pH, e.g., greater than about 12. Further, the activator complex aids in the production of oxygen gas at an alkaline pH, which, in some embodiments, is necessary due to the pH restrictions of the surface being cleaned.

Such oxygen production aids in facilitating soil removal by generating mechanical action on and in the soil, in addition to the normal bleaching and cleaning action of an oxygen producing source. It is thought that the active oxygen source penetrates the soil. When the active oxygen source within the soil is contacted by the activator complex, oxygen gas is produced within the soil. As the oxygen gas is being produced, it breaks up the soil from within. As an aqueous cleaning solution, e.g., an alkaline override use solution or a rinse step, is passed over or through the surface, the broken up soil is washed away.

The amount of activator complex used in the methods of the present invention is dependent on a variety of factors including, the active oxygen source present in the active oxygen use solution, the type of surface to be cleaned, and the amount and type of soil present on the surface. The amount of activator complex used is also dependent on the size the particular activator complex chosen.

In some embodiments, the amount of activator complex applied is about 0.0001 wt-% to about 1.0 wt-% of the use solution in which it is applied to the surface, e.g., as part of an alkaline override use solution, or as an aqueous solution applied to the surface to be cleaned after the application of an active oxygen use solution. Acceptable levels of activator complex present are about 0.005 to about 0.5 wt-%; 0.01 wt-% is a particularly suitable level.

In some embodiments, the amount of activator complex added will be such that the production of oxygen from the reaction between the activator complex and the active oxygen source is controlled over time. This is particularly desirable when cleaning surfaces such as membranes. Membranes provide for a large surface area in a small space. This surface area acts as a large nucleation site for the reaction to occur. Thus, in some embodiments, it is desirable to be able to control the amount of oxygen gas released on the surface at any one time so as to not damage the membrane surface. In some embodiments, the concentration of the activator complex added is varied to provide a controlled release of oxygen gas on the surface to be cleaned.

### Alkaline Override Use Solutions

In some aspects, the methods of the present invention include applying an alkaline override use solution to the surface to be cleaned at the same time, and/or before, and/or after an active oxygen use solution has been applied to the surface. In some embodiments, the alkaline override use solution includes an activator complex. In other embodiments, an activator complex is applied to the surface prior to the application of an alkaline override use solution. The alkaline override use solution selected is dependent on a variety of factors, including, but not limited to, the type of soil to be removed, and the surface from which the soil is removed.

Alkalinity Source

In some aspects, the alkaline override use solution for use with the methods of the present invention includes a source of alkalinity. Exemplary alkaline sources suitable for use with the methods of the present invention include, but are not limited to, basic salts, amines, alkanol amines, carbonates and silicates. Other exemplary alkaline sources for use with the methods of the present invention include NaOH (sodium hydroxide), KOH (potassium hydroxide), TEA (triethanol amine), DEA (diethanol amine), MEA (monoethanolamine), sodium carbonate, and morpholine, sodium metasilicate and potassium silicate. The alkaline source selected is compatible with the surface to be cleaned.

The amount of alkaline source in the alkaline override use solution is dependent on a variety of factors including, the type of surface to be cleaned, and the amount and type of soil present on the surface. In some embodiments, the amount of alkaline source included in the alkaline override use solution is about 0.05 wt-% to about 10 wt-%. Suitable levels of alkaline include about 0.05 to about 1 wt-% and about 0.75 to about 1.5 wt-%.

In some embodiments, the pH of the alkaline override use solution is about 10 to about 13. In some embodiments, the pH is about 12. The pH of the alkaline override use solution is formulated to facilitate soil removal from the selected surface, while also being compatible with the selected surface. In some embodiments, the pH of the total solution used to clean the surface, i.e., the pH of the solution after both the active oxygen use solution and the alkaline override use solutions have been applied to the surface, is about 10 to about 11.5.

In some embodiments, the alkaline override use solution is applied to the surface to be cleaned at the same time, or after an acidic active oxygen use solution has been applied to the surface. The pH of the alkaline override use solution is adjusted to neutralize the acidity of the active oxygen use solutions and to provide an alkaline cleaning environment. Thus the pH of the alkaline override use solution itself can be higher than the pH of the resulting solution.

### Additional Functional Ingredients

In some embodiments, the active oxygen use solution and/or the alkaline override use solution include additional functional ingredients. The additional functional ingredients selected facilitate soil removal from the surface to be cleaned. Additional functional ingredients for use with the methods of the present invention include, for example, surfactants, builders and buffers.

Surfactants

A surfactant or mixture of surfactants can be present in the active oxygen use solution, and/or the alkaline override use solution of the present invention. The surfactant chosen can be compatible with the surface to be cleaned. Examples of suitable surfactants include nonionic, cationic, and anionic surfactants.

### Nonionic Surfactants

In some embodiments, the surfactant is a nonionic surfactant. Nonionic surfactants improve soil removal and can reduce the contact angle of the solution on the surface being treated.

Nonionic surfactants useful in the invention are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties.

Nonionic surfactants that can be used with the methods of the present invention include, but are not limited to: (1) block polyoxypropylene-polyoxyethylene polymeric compounds such as Pluronic® and Tetronic® manufactured by BASF Corp.; (2) condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide such as Igepal® manufactured by Rhodia and Triton® manufactured by Union Carbide; (3) condensation products of one mole of a saturated or unsaturated, straight or branched chain alcohol having from about 6 to about 24 carbon atoms with from about 3 to about 50 moles of ethylene oxide such as Neodol® manufactured by Shell Chemical Co. and Alfonic® manufactured by Vista Chemical Co.; (4) condensation products of one mole of saturated or unsaturated, straight or branched chain carboxylic acid having from about 8 to about 18 carbon atoms with from about 6 to about 50 moles of ethylene oxide such as Nopalcol® manufactured by Henkel Corporation and Lipopeg® manufactured by Lipo Chemicals, Inc.; (5) block polyoxypropylene-polyoxyethylene polymeric compounds which are modified, essentially reversed, by adding ethylene oxide to ethylene glycol to provide a hydrophile of designated molecular weight; and, then adding propylene oxide to obtain hydrophobic blocks on the outside (ends) of the molecule such as Pluronic® R surfactants manufactured by BASF; (6) compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof, (7) the alkylphenoxypolyethoxyalkanols described in U.S. Pat. No. 2,903,486; (8) polyhydroxy fatty acid amide surfactants; (9) the alkyl ethoxylate condensation products of aliphatic alcohols; (10) the ethoxylated C₆-C₁₈ fatty alcohols and C₆-C₁₈ mixed ethoxylated and propoxylated fatty alcohols; (11) suitable nonionic alkylpolysaccharide surfactants, particularly for use in the present compositions include those disclosed in U.S. Pat. No. 4,565,647; (12) fatty acid amide surfactants; (13) the class defined as alkoxylated amines or, most particularly, alcohol alkoxylated/aminated/alkoxylated surfactants, and mixtures thereof.

Other exemplary nonionic surfactants for use with the methods of the present invention are disclosed in the treatise Nonionic Surfactants, edited by Schick, M. J., Vol. 1 of the Surfactant Science Series, Marcel Dekker, Inc., New York, 1983, the contents of which is incorporated by reference herein. A typical listing of nonionic classes, and species of these surfactants, is also given in U.S. Pat. No. 3,929,678. Further examples are given in “Surface Active Agents and Detergents” (Vol. I and II by Schwartz, Perry and Berch). The disclosures of these references relating to nonionic surfactants are incorporated herein by reference.

### Semi-Polar Nonionic Surfactants

In some embodiments, semi-polar nonionic surfactants are used with the methods of the present invention. Exemplary semi-polar nonionic surfactants include, but are not limited to, the amine oxides, phosphine oxides, sulfoxides and their alkoxylated derivatives.

### Anionic Surfactants

In some embodiments, an anionic surfactant is selected for use in the methods of the present invention. Anionic surfactants are surface active substances having a negative charge on the hydrophobe or have a hydrophobic section that carries no charge unless the pH is elevated to neutrality or above (e.g. carboxylic acids). Carboxylate, sulfonate, sulfate, and phosphate are the polar (hydrophilic) solubilizing groups found in anionic surfactants. Of the cations (counter ions) associated with these polar groups, sodium, lithium, and potassium impart water solubility; ammonium and substituted ammonium ions provide both water and oil solubility; and, calcium, barium, and magnesium promote oil solubility.

Anionics can be useful additives' to compositions for use with the methods of the present invention. Anionic surface active compounds can be useful to impart special chemical or physical properties other than detergency within the composition. Anionics can be employed as gelling agents or as part of a gelling or thickening system. Anionics are excellent solubilizers and can be used for hydrotropic effect and cloud point control.

The majority of large volume commercial anionic surfactants can be subdivided into five major chemical classes and additional sub-groups known to those of skill in the art and described in “Surfactant Encyclopedia,” Cosmetics & Toiletries, Vol. 104 (2) 71-86 (1989). The first class includes acylamino acids (and salts), such as acylgluamates, acyl peptides, sarcosinates (e.g. N-acyl sarcosinates), taurates (e.g. N-acyl taurates and fatty acid amides of methyl tauride), and the like. The second class includes carboxylic acids (and salts), such as alkanoic acids (and alkanoates), ester carboxylic acids (e.g. alkyl succinates), ether carboxylic acids, and the like. The third class includes phosphoric acid esters and their salts. The fourth class includes sulfonic acids (and salts), such as isethionates (e.g. acyl isethionates), alkylaryl sulfonates, alkyl sulfonates, sulfosuccinates (e.g. monoesters and diesters of sulfosuccinate), and the like. The fifth class includes sulfuric acid esters (and salts), such as alkyl ether sulfates, alkyl sulfates, and the like.

Further examples of suitable anionic surfactants are given in “Surface Active Agents and Detergents” (Vol. I and II by Schwartz, Perry and Berch). A variety of such surfactants are also generally disclosed in U.S. Pat. No. 3,929,678. The disclosures of the above references relating to anionic surfactants are incorporated herein by reference.

In some embodiments, the surfactant selected is a linear alkyl benzene sulfonate, an alcohol sulfate, an amine oxide (e.g., dimethyl amine oxide), an alcohol ethoxylate, an alkyl phenol ethoxylate, a polyethylene glycol ester (e.g., Tween), an EO/PO block copolymer and derivatives and mixtures thereof. In some embodiments, a linear alkyl benzene sulfonates is selected for use with the methods of the present invention.

### Cationic Surfactants

Cationic surfactants can also be used in the methods of the present invention. Surface active substances are classified as cationic if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RnX+Y— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants can refer to compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like. The disclosures of cationic surfactants in the above references are incorporated herein by reference.

### Amphoteric Surfactants

Amphoteric surfactants can be used with the methods of the present invention. Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

A typical listing of amphoteric classes, and species of these surfactants, is given in U.S. Pat. No. 3,929,678. Further examples are given in “Surface Active Agents and Detergents” (Vol. I and II by Schwartz, Perry and Berch). The disclosures of amphoteric surfactants in the above-identified references are incorporated herein by reference.

### Zwitterionic Surfactants

In some embodiments, zwitterionic surfactants are used with the methods of the invention. Zwitterionic surfactants can be thought of as a subset of the amphoteric surfactants. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate. Betaine and sultaine surfactants are exemplary zwitterionic surfactants for use herein.

A typical listing of zwitterionic classes, and species of these surfactants, is given in U.S. Pat. No. 3,929,678. Further examples are given in “Surface Active Agents and Detergents” (Vol. I and II by Schwartz, Perry and Berch). The disclosures of zwitterionic surfactants in the above references are incorporated herein by reference.

In some embodiments, the active oxygen use solution, and/or alkaline override use solution includes a surfactant or mixture of surfactants. The amount of surfactant in the active oxygen use solution and/or alkaline override use solution is about 0.001 wt % to about 10 wt %. Acceptable levels of surfactant include about 0.01 wt % to about 4 wt %. In some embodiments, about 0.025 wt % of a surfactant or mixture of surfactants is present in the active oxygen and/or alkaline override use solution. It is to be understood that all values and ranges between these values and ranges are encompassed by the present invention.

### Surfactant Compositions

The surfactants described hereinabove can be used singly or in combination with the methods of the present invention. In particular, the nonionics and anionics can be used in combination. The semi-polar nonionic, cationic, amphoteric and zwitterionic surfactants can be employed in combination with nonionics or anionics. The above examples are merely specific illustrations of the numerous surfactants which can find application within the scope of this invention. It should be understood that the selection of particular surfactants or combinations of surfactants can be based on a number of factors including compatibility with the membrane at the intended use concentration and the intended environmental conditions including temperature and pH. Accordingly, one should understand that surfactants that may damage a particular membrane during conditions of use should not be used with that membrane. It is expected that the same surfactant, however, may be useful with other types of membranes. In addition, the level and degree of foaming under the conditions of use and in subsequent recovery of the composition can be a factor for selecting particular surfactants and mixtures of surfactants. For example, in certain applications it may be desirable to minimize foaming and, as a result, one would select a surfactant or mixture of surfactants that provides reduced foaming. In addition, it may be desirable to select a surfactant or a mixture of surfactants that exhibits a foam that breaks down relatively quickly so that the composition can be recovered and reused with an acceptable amount of down time. In addition, the surfactant or mixture of surfactants can be selected depending upon the particular soil that is to be removed.

It should be understood that the compositions for use with the methods of the present invention need not include a surfactant or a surfactant mixture, and can include other components. In addition, the compositions can include a surfactant or surfactant mixture in combination with other components. Exemplary additional components that can be provided within the compositions include builders, water conditioning agents, non-aqueous components, adjuvants, carriers, processing aids, enzymes, and pH adjusting agents.

Builders

The cleaning solutions, i.e., the active oxygen use solution and/or the alkaline override use solution, can further include a builder or mixture of builders. In some embodiments, the alkaline override use solution includes a builder. Builders include chelating agents (chelators), sequestering agents (sequestrants), detergent builders, and the like. The builder often stabilizes the composition or solution. Builders suitable for use with the methods of the present invention preferably do not complex with the activator complex. That is, the builder or builders for use with the present invention are selected such that they preferentially complex with the mineral soil broken up after the oxygen gas has been generated in situ on and in the soil, rather than with the activator complex.

Builders and builder salts can be inorganic or organic. Examples of builders suitable for use with the methods of the present invention include, but are not limited to, phosphonic acids and phosphonates, phosphates, aminocarboxylates and their derivatives, pyrophosphates, polyphosphates, ethylenediamene and ethylenetriamene derivatives, hydroxyacids, and mono-, di-, and tri-carboxylates and their corresponding acids. Other builders include aluminosilicates, nitroloacetates and their derivatives, and mixtures thereof. Still other builders include aminocarboxylates, including salts of hydroxyethylenediaminetetraacetic acid (HEDTA), and diethylenetriaminepentaacetic acid.

Exemplary commercially available chelating agents for use with the methods of the present invention include, but are not limited to: sodium tripolyphosphate available from Innophos; Trilon A® available from BASF; Versene 100®, Low NTA Versene®, Versene Powder®, and Versenol 120® all available from Dow; Dissolvine D-40 available from BASF; and sodium citrate.

In some embodiments, a biodegradable aminocarboxylate or derivative thereof is present as a builder in the methods of the present invention. Exemplary biodegradable aminocarboxylates include, but are not limited to: Dissolvine GL-38® and Dissolvine GL-74® both available from Akzo; Trilon M® available from BASF; Baypure CX100® available from Bayer; Versene EDG® available from Dow; HIDS® available from Nippon Shakubai; Octaquest E30® and Octaquest A65® both available from Finetex/Innospec Octel.

In some embodiments, an organic chelating agent is used. Organic chelating agents include both polymeric and small molecule chelating agents. Organic small molecule chelating agents are typically organocarboxylate compounds or organophosphate chelating agents. Polymeric chelating agents commonly include polyanionic compositions such as polyacrylic acid compounds. Small molecule organic chelating agents include N-hydroxyethylenediaminetriacetic acid (HEDTA), ethylenediaminetetraacetic acid (EDTA), nitrilotriaacetic acid (NTA), diethylenetriaminepentaacetic acid (DTPA), ethylenediaminetetraproprionic acid triethylenetetraaminehexaacetic acid (TTHA), and the respective alkali metal, ammonium and substituted ammonium salts thereof. Aminophosphonates are also suitable for use as chelating agents with the methods of the invention and include ethylenediaminetetramethylene phosphonates, nitrilotrismethylene phosphonates, and diethylenetriamine-(pentamethylene phosphonate) for example. These aminophosphonates commonly contain alkyl or alkenyl groups with less than 8 carbon atoms.

Other suitable sequestrants include water soluble polycarboxylate polymers. Such homopolymeric and copolymeric chelating agents include polymeric compositions with pendant (—CO₂H) carboxylic acid groups and include polyacrylic acid, polymethacrylic acid, polymaleic acid, acrylic acid-methacrylic acid copolymers, acrylic-maleic copolymers, hydrolyzed polyacrylamide, hydrolyzed methacrylamide, hydrolyzed acrylamide-methacrylamide copolymers, hydrolyzed polyacrylonitrile, hydrolyzed polymethacrylonitrile, hydrolyzed acrylonitrile methacrylonitrile copolymers, or mixtures thereof. Water soluble salts or partial salts of these polymers or copolymers such as their respective alkali metal (for example, sodium or potassium) or ammonium salts can also be used. The weight average molecular weight of the polymers is from about 4000 to about 12,000. Preferred polymers include polyacrylic acid, the partial sodium salts of polyacrylic acid or sodium polyacrylate having an average molecular weight within the range of 4000 to 8000.

Preferred builders for use with the methods of the present invention are water soluble. Water soluble inorganic alkaline builder salts which can be used alone or in admixture with other builders include, but are not limited to, alkali metal or ammonia or substituted ammonium salts of carbonates, silicates, phosphates and polyphosphates, and borates. Water soluble organic alkaline builders which are useful in the present invention include alkanolamines and cyclic amines.

Particularly preferred builders include PAA (polyacrylic acid) and its salts, phosphonobutane carboxylic acid, HEDP (1-Hydroxyethylidene-1,1-Diphosphonic Acid), EDTA and sodium gluconate.

The amount of builder in the alkaline override use solution, if present, in some embodiments, is about 0.001 wt % to about 5 wt %. In some embodiments, about 0.005 wt % to about 0.1 wt % of builder is present. Acceptable levels of builder include about 0.05 wt % to about 2.5 wt %.

Optional Adjuvants

In addition, various other additives or adjuvants may be present in compositions of the present invention to provide additional desired properties, either of form, functional or aesthetic nature, for example:

a) Solubilizing intermediaries called hydrotropes can be present in the compositions of the invention of such as xylene-, toluene-, or cumene sulfonate; or n-octane sulfonate; or their sodium-, potassium- or ammonium salts or as salts of organic ammonium bases. Also commonly used are polyols containing only carbon, hydrogen and oxygen atoms. They preferably contain from about 2 to about 6 carbon atoms and from about 2 to about 6 hydroxy groups. Examples include 1,2-propanediol, 1,2-butanediol, hexylene glycol, glycerol, sorbitol, mannitol, and glucose.

b) Nonaqueous liquid carrier or solvents can be used for varying compositions for use with the methods of the present invention.

c) Viscosity modifiers may be added to the compositions for use with the methods of the present invention. These can include natural polysaccharides such as xanthan gum, carrageenan and the like; or cellulosic type thickeners such as carboxymethyl cellulose, and hydroxymethyl-, hydroxyethyl-, and hydroxypropyl cellulose; or, polycarboxylate thickeners such as high molecular weight polyacrylates or carboxyvinyl polymers and copolymers; or, naturally occurring and synthetic clays; and finely divided fumed or precipitated silica, to list a few.

d) Solidifiers may be used to prepare solid form of a composition for use with the methods of the present invention. These could include any organic or inorganic solid compound having a neutral inert character or making a functional, stabilizing or detersive contribution to the intended embodiment. Examples are polyethylene glycols or polypropylene glycols having molecular weight of from about 1,400 to about 30,000; and urea.

### Methods of Cleaning

In some aspects, the present invention provides methods for removing soil from a surface including: applying an active oxygen use solution to the surface; applying an alkaline override use solution; and rinsing the surface. This process maybe repeated as necessary. There is no rinse step required between the application of the active oxygen use solution and the application of the alkaline override use solution. In some embodiments, the active oxygen use solution includes an active oxygen source. In some embodiments, an activator complex is included in the alkaline override use solution. In other embodiments, an activator complex is applied to the surface after the application of an active oxygen use solution to the surface, but before the application of an alkaline override use solution to the surface, i.e., the activator complex is applied as a separate composition. Any combination and application order of activator complex, active oxygen use solution, and alkaline override use solution that results in oxygen gas generation on and in the soil, and soil removal, from the selected surface can be used.

In other embodiments, all three components, i.e., active oxygen use solution, activator complex, and alkaline override use solution are applied to the surface at the same time. This application can be followed by a rinse step, and the cleaning step can be repeated. The simultaneous application of all three components can also be followed by a rinse step, and then any other combination and order of application of active oxygen use solution, activator complex, and alkaline override use solution. For example, all three components, i.e., active oxygen use solution, activator complex, and alkaline override use solution, can be applied to the surface at the same time. The surface is then rinsed. Then, an active oxygen use solution is applied to the surface. An alkaline override use solution including an activator complex is then applied to the surface, without first rinsing the surface. The surface is then rinsed.

In still yet other embodiments, the active oxygen solution can be passed over a solid source of activator complex, or an aqueous solution including an activator complex could be passed or a solid composition including an active oxygen source. The resulting solution can then be circulated through a CIP system. In some embodiments, the resulting solution is run through the system at the same time as the alkaline override use solution. In other embodiments, an alkaline override use solution is applied after the solution has been run through the system, but before the system has been rinsed.

In other embodiments, an activator complex can be incorporated into a solid composition containing an active oxygen source, e.g., a peroxygen compound. An alkaline override use solution can then be run over the solid to create an activated cleaning solution. Without wishing to be bound by any particular theory, it is thought that the presence of the activator complex and the active oxygen source in the solid will provide for a fast dissolving solid. The timing of the dissolution of the solid can be controlled through the use of chelating agents and/or coatings or encapsulation of the activator complex.

The methods of the present invention provide increased cleaning, i.e., increased soil removal, while requiring fewer steps and/or less time per step compared to conventional cleaning techniques. The methods of the present invention also require less water consumption compared to conventional cleaning techniques. For example, a conventional chlorine wash applied to membranes includes the following steps: first an alkaline wash or an alkaline wash with chlorine is applied for 30 to 60 minutes, then the surface is rinsed. Next an acid wash is applied to the surface for 20 to 40 minutes, and then the surface is rinsed. Finally an alkaline, or alkaline with chlorine rinse is applied to the surface for 30 to 60 minutes, and thereafter rinsed. A conventional enzyme wash applied to membranes includes the following steps: first an alkaline with enzyme wash is applied to the surface for 30 to 60 minutes, and then rinsed. Next an acid wash is applied to the surface for 20 to 40 minutes, and then rinsed. Finally an alkaline or alkaline with chlorine wash is applied to the surface for 30 to 60 minutes, and then rinsed.

The methods of the present invention require only the application of an active oxygen use solution, followed by an activated wash, i.e., an alkaline override use solution including an activator complex, or an activator complex followed by an alkaline override use solution, and then a rinse. The methods of the present invention do not require multiple rinses between the application of the active oxygen and activated wash. Thus the methods of the present invention conserve both time and water. Additionally, the methods of the present invention result in a reduction of chlorinated VOCs compared to conventional chlorine cleaning methods.

### Surfaces

Surfaces capable of being cleaned using the methods of the present invention include any surface that is sensitive to heat and/or that has pH limitations, including, but not limited to membranes, medical devices, laundry and/or textiles, and hard surfaces such as floors, and walls.

In some embodiments, the surfaces to be cleaned are surfaces which are normally cleaned using a clean-in-place (CIP) cleaning technique. Examples of such surfaces include evaporators, heat exchangers (including tube-in-tube exchangers, direct steam injection, and plate-in-frame exchangers), heating coils (including steam, flame or heat transfer fluid heated) re-crystallizers, pan crystallizers, spray dryers, drum dryers, and tanks.

Membranes

In some aspects, the surface to be cleaned using the methods of the present invention is a membrane. The membranes that can be treated according to the invention include those membranes that are designed for periodic cleaning, and are often utilized in various applications requiring separation by filtration. Exemplary industries that utilize membranes that can be treated according to the invention include the food industry, the beverage industry, the biotechnology industry, the pharmaceutical industry, the chemical industry, and the water purification industry. In the case of the food and beverage industries, products including milk, whey, fruit juice, beer, and wine are often processed through a membrane for separation. The water purification industry often relies upon membranes for desalination, contaminant removal, and waste water treatment. An exemplary use of membranes in the chemical industry includes electropaint processes.

Membranes that can be treated according to the invention include those provided in the form of spiral wound membranes, plate and frame membranes, tubular membranes, capillary membranes, hollow fiber membranes and the like. In the case of spiral wound membranes, it is expected that the industrial commonly available diameters of 3.8 inch, 6.2 inch, and 8.0 inch can be treated using the methods of the present invention. The membranes can be generally characterized according to the size of the particles being filtered. Four common types of membrane types include microfiltration (MF) membranes, ultrafiltration (UF) membranes, nanofiltration (NF) membranes, and reverse osmosis (RO) membranes.

Because of the pore sizes, each membrane process operates at an optimal pressure. Microfiltration membrane systems generally operate at pressures less than about 30 psig. Ultrafiltration membrane systems generally operate at pressures of about 15-150 psig. Nanofiltration membrane systems generally operate at pressures of about 75-500 psig. Reverse osmosis membrane systems generally operate at pressures of about 200-2000 psig. Membranes can be formed from a variety of materials that are commonly used to form membranes including cellulose acetate, polyamide, polysulfone, vinylidene fluoride, acrylonitrile, stainless steel, ceramic, etc. These various membrane chemical types and other materials of construction may have specific pH, oxidant, solvent, chemical compatibility restrictions, and/or pressure limitations.

In some embodiments, the membrane to be cleaned is selected from the group consisting of a microfiltration membrane (MF), an ultrafiltration membrane (UF), a nanofiltration membrane (NF), and a reverse osmosis membrane (RO). In some embodiments, the membrane to be cleaned is a membrane used in a dairy application. For example, in some embodiments a MF membrane used for fat removal, bacteria removal, and brine clarification is selected. In other embodiments, a UF membrane used for whole and skim milk fractionation, whey protein fractionation, and cheese brine clarification is selected. In yet other embodiments, a NF membrane used for demineralization of salt whey, concentration of UF permeate, clarification of brine, and acid whey clarification is selected. In still other embodiments, a RO membrane used for the concentration of whole and skim milk, concentration of whey, concentration of UF permeate, reduction of biological oxygen demand and to polish permeate and condensate is used.

Time

In some aspects, the methods of the present invention include applying a active oxygen use solution to a surface to be cleaned. The active oxygen use solution is applied to the surface for an amount of time sufficient to penetrate and/or solubilize the soil. In some embodiments, the active oxygen use solution is applied for about 2 to about 30 minutes. In other embodiments, the active oxygen use solution is applied for about 5 to about 15 minutes. When used in a CIP process, the active oxygen use solution is circulated through the entire system for at least one full cycle.

In some aspects, the methods of the present invention include applying an activator complex to the surface to be cleaned, after the active oxygen use solution is applied. In some embodiments, the activator complex is applied alone and then followed by an alkaline override use solution. In other embodiments, the activator complex is applied as part of an alkaline override use solution. The activator complex, either alone or as part of the alkaline override use solution, is applied to the surface to be cleaned for about 15 to about 75 minutes. In some embodiments, the activator complex, either alone or as part of the alkaline override use solution, is applied to the surface to be cleaned for about 30 to about 60 minutes. In some embodiments, the activator complex is applied to the surface separately from the alkaline override use solution for about 30 to about 60 minutes.

The alkaline override use solution is applied to the surface to be cleaned for an amount of time sufficient to promote cleaning of the surface. In some embodiments, the alkaline override use solution is applied to the surface for about 30 to about 60 minutes. In still yet other embodiments, the active oxygen use solution, activator complex, and alkaline override use solution are applied to the surface to be cleaned for about 5 to about 15 minutes

Temperature

In some aspects, the present invention is directed to methods for cleaning surfaces that are sensitive to high temperatures. Use of an activator complex in combination with an active oxygen source, and an alkaline override use solution, allows for increased cleaning at an alkaline pH compared to conventional cleaning methods, without the use of high temperatures. For example, in some embodiments, the methods of the present invention are used for removing soil from a membrane. Membranes have specific temperature limitations due to their structure. For example, a UF membrane cannot tolerate temperatures above about 125° F., and RO membranes cannot tolerate temperatures about 120° F. The methods of the present invention allow for increased cleaning and sanitizing of membranes, without the need for increased temperatures. In some embodiments, the cleaning methods of the present invention are performed at about 60° F. to about 125° F. In some embodiments, the cleaning methods of the present invention are performed at about 118° F. In some embodiments, the cleaning methods of the present invention are performed at a temperature less than about 122° F.

pH

In some embodiments, the methods of the present invention are used to remove soil from the surface of a membrane. Membranes have specific pH limitations that restrict the pH of any use solution applied thereto. In some embodiments, an acidic active oxygen use solution is applied to a membrane. The pH of the acidic active oxygen use solution is compatible with the surface of the membrane. In some embodiments, the pH is between about 1 to about 5. In other embodiments, the pH is about 2. The pH will be determined by the limitations of the surface selected to be cleaned.

In some embodiments, an alkaline override use solution is applied to a membrane after an acidic active oxygen use solution has been applied to the surface, wherein there is no rinse step between the two steps. In other embodiments, the active oxygen use solution, and alkaline override use solution are applied to the surface at the same time. The pH of the alkaline override use solution is compatible with the surface to be cleaned. When used to clean a membrane, the pH of the alkaline override use solution is such that when applied after, or at the same time as an acidic active oxygen use solution the pH of the combined solutions is about 11. In some embodiments, the pH of the alkaline override use solution is between about 10 and about 13.

### Additional Uses

In addition to the methods of cleaning described herein, the methods of the present invention can further be used to sanitize a membrane. Without wishing to be bound by any particular theory, it is thought that because the methods of the present invention conclude on an alkaline step, the methods result in improved initial production fluxes and product yields, while still acting as an antimicrobial/sanitizing treatment.

### EXAMPLES

The following materials, methods and examples are meant to be illustrative only and are not intended to be limiting.

### Example 1

### Method for Cleaning a UF Membrane

The methods of the present invention were evaluated for use in cleaning an ultrafiltration membrane. An acidic active oxygen use solution including about 74% hydrogen peroxide, about 3.5% pelargonic acid, about 3.0% methane sulfonic acid, as well as additional components, e.g., builders, was used for the following tests. An alkaline override use solution including about 97% NaOH (50%) and about 1.4% sodium gluconate (40%) was also used for each of the following tests.

Test 1

An ultrafiltration (UF) membrane used to process sweet whey was cleaned. Specifically, a UF membrane made of polysulfone was first treated with 0.5 wt % of the acidic active oxygen use solution described above for about 5 minutes at a pH of about 3.6. 0.2 wt % of the alkaline override use solution described above was then run through the system for about 5 minutes at a pH of about 11.4. 0.4wt % of an activator complex, i.e., KI, was then run through the system for about 15-30 minutes at a pH of about 11.6. The membrane was then rinsed, and the process was repeated. Table 1 summarizes the cleaning protocol.

TABLE 1

| | | | | Active |
|---|---|---|---|---|
| | Time | | | Oxygen |
| Step | (min) | Chemistry | pH | (ppm) |
| Wash #1 | 0-5 | 0.5% Acidic Active Oxygen | 3.6 | 710.17 |
| | | Use Solution | | |
| | 5 | 0.2% Alkaline Override Use | 11.4 | 665.99 |
| | | Solution | | |
| | 15-30 | 0.4% Activator Complex | 11.6 | 177.66 |

Rinse

| | | | | |
|---|---|---|---|---|
| Wash #2 | 0-5 | 0.5% Acidic Active Oxygen | 3.9 | 532.51 |
| | | Use Solution | | |
| | 5 | 0.2% Alkaline Override Use | 11.6 | 621.34 |
| | | Solution | | |
| | 15-30 | 0.4% Activator Complex | 11.6 | 133.01 |

Rinse

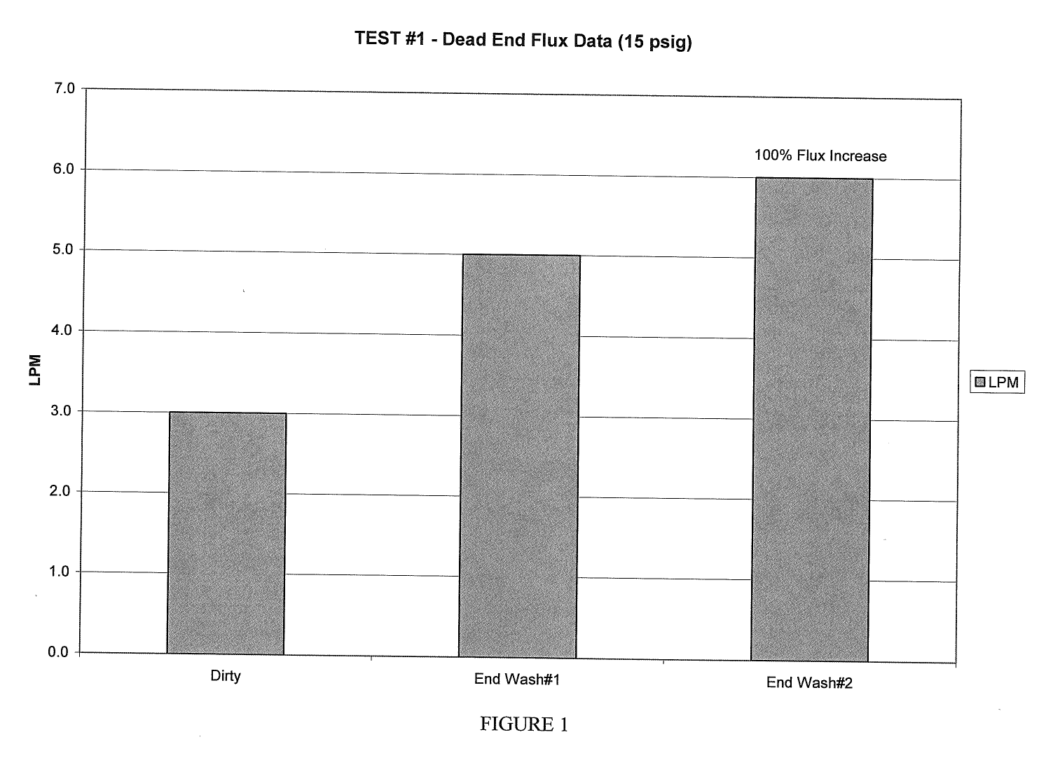

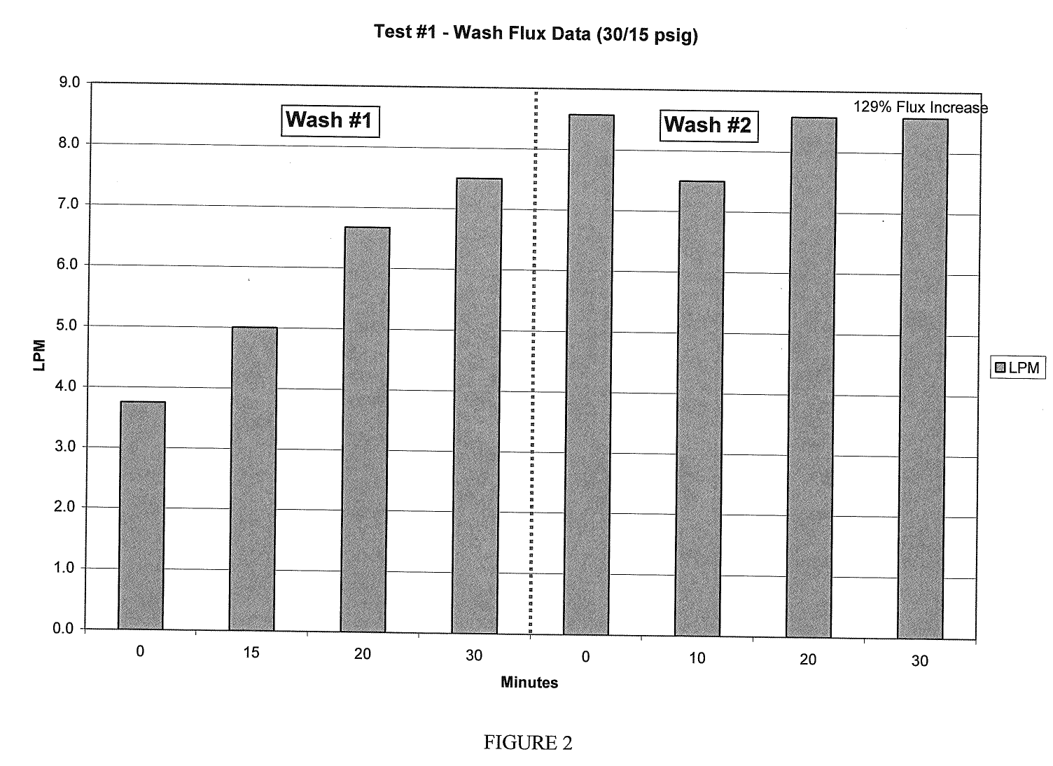

The total active oxygen titration, pH, and temperature of the solution were measured. The initial water flux, and dead-end water flux throughout the cleaning cycle of the membrane were also measured (data shown as liters per minute (LPM)). FIG. 1 graphically depicts the dead-end water flux throughout the cleaning cycle. As can be seen in FIG. 1, at the end of wash #2 , there was a 100% flux increase. FIG. 2 graphically depicts the wash flux data over the course of wash #1 and wash #2. As can be seen in this figure, there was a 129% flux increase by minute 30 of wash #2.

As can be seen in Table 1, the amount of active oxygen over time during wash #1 decreased.

It is thought that water fluxes remain the best indirect measurement of membrane cleanliness. Based on the water fluxes discussed above, this cleaning method removed soil from the UF membrane without the use of high temperature and/or high alkalinity. Further, this cleaning method reduced the amount of water needed to effectively remove soil the membrane.

Test 2

Test #2 was run to determine the outcome when the activator complex is added earlier in the wash process. Test #2 also evaluated the cleaning achieved when a mixture of activator complexes were used, i.e., KI and ammonium molybdate. A UF membrane made of polysulfone was first treated with 0.5 wt % of the acidic active oxygen use solution described above for about 5 minutes at a pH of about 3.0. 0.2 wt % of the alkaline override use solution described above was then run through the system for about 5 minutes at a pH of about 11.6. After 5 minutes (at minute 10) about 0.4 wt % of an activator complex, i.e., KI, was run through the system for about 20 minutes at a pH of about 12.3. The membrane was then rinsed, and the process was repeated. During the second wash (wash #2), a mixture of activator complexes was applied to the membrane. Specifically, a mixture of 0.1 wt % KI, and 0.09 wt % Mo were added at minute 10. Table 2 summarizes the cleaning protocol.

TABLE 2

| | Time | | | Active Oxygen |
|---|---|---|---|---|
| Step | (min) | Chemistry | pH | (ppm) |
| Wash | 0-5 | 0.5% Acidic Active Oxygen Use | 3.0 | 799 |
| #1 | | Solution | | |
| | 5 | 0.2% Alkaline Override Use | 11.6 | 577.16 |
| | | Solution | | |
| | 10-30 | 0.4% Activator Complex (KI) | 12.3 | 88.83 |

Rinse

| | | | | |
|---|---|---|---|---|
| Wash | 0-5 | 0.5% Acidic Active Oxygen Use | 4.2 | 621.34 |
| #2 | | Solution | | |
| | 5 | 0.2% Alkaline Override Use | 11.4 | 399.50 |
| | | Solution | | |
| | 10-30 | 0.19% Activator Complex (0.1% | 11.7 | 133.01 |
| | | KI, 0.09% Mo) | | |

Rinse

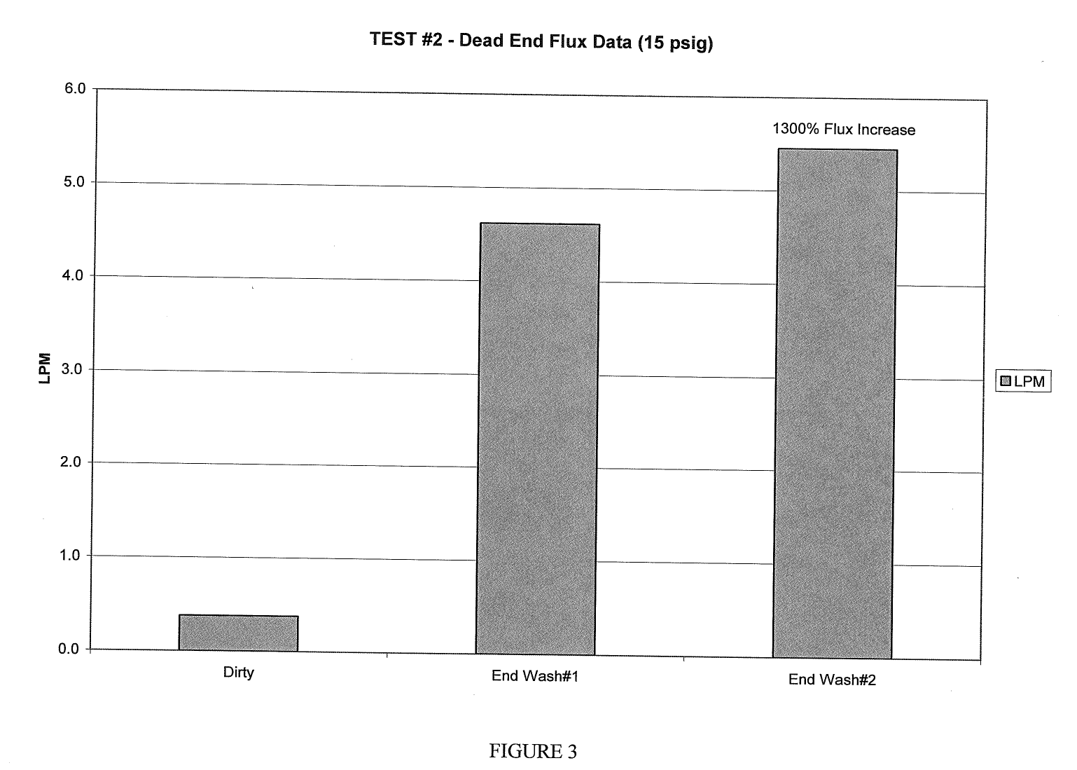

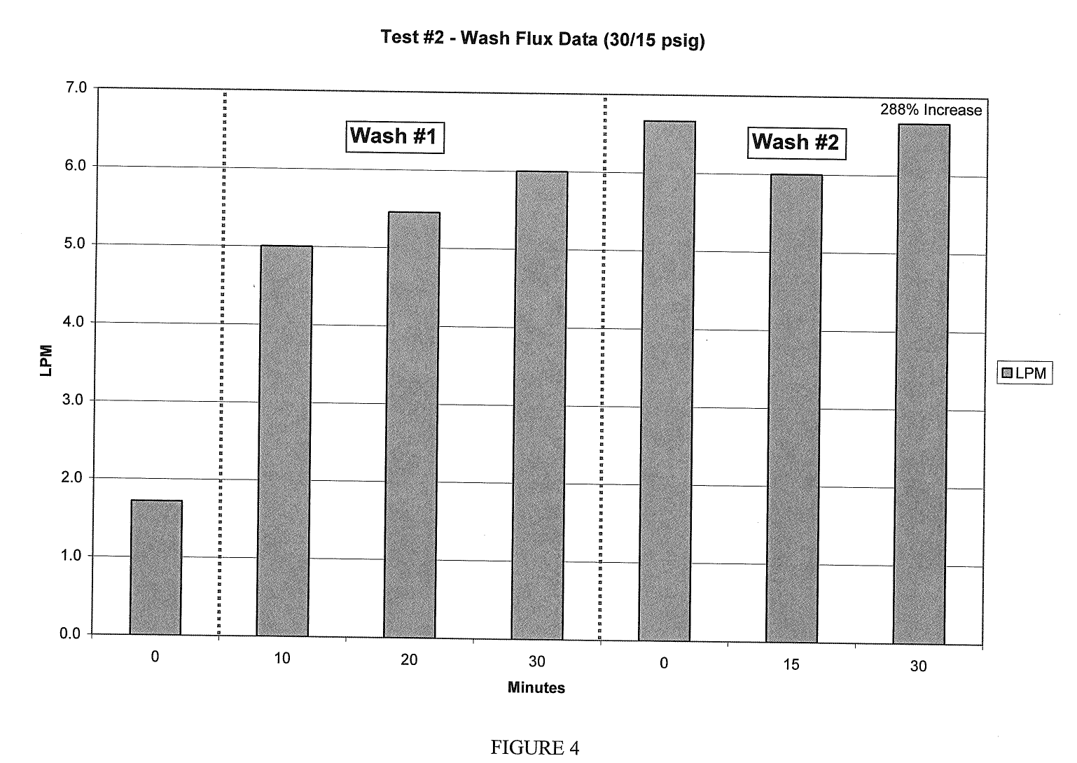

FIG. 3 graphically depicts the dead end flux data (LPM) of the dirty membrane, compared with the membrane after the end of wash #1 and after the end of wash #2. As can be seen in this figure, there was a 1300% flux increase by the end of wash #2 as compared to the dirty membrane. FIG. 4 graphically depicts the wash flux data (LPM) as measured throughout wash #1 and wash #2. As can be seen in this figure, by the end of wash #2 there was a 288% increase in the solution flowing through the membrane.

As can be seen in Table 2, the amount of available oxygen decreases over the course of the wash, indicating that adequate activation was achieved.

Test #3

Test #3 was run to determine the outcome when less activator complex (KI) was added earlier in the alkaline step. Additionally, ammonium molybdate was added to act as an additional activator complex. A UF membrane made of polysulfone was first treated with 5 0.5 wt % of the acidic active oxygen use solution described above for about 5 minutes at a pH of about 3.5. 0.2 wt % of the alkaline override use solution described above was then run through the system for about 5 minutes at a pH of about 11.4. After 5 minutes (at minute 10) a mixture of activator complexes, i.e., 0.04 wt % KI, and 0.09 wt % ammonium molybdate, were run through the system for about 20 minutes at a pH of about 11.5. The membrane was then rinsed, and the process was repeated. Each wash was performed at a temperature of about 113° F. Table 3 summarizes the cleaning protocol.

TABLE 3

| | Time | | | Active Oxygen |
|---|---|---|---|---|
| Step | (min) | Chemistry | pH | (ppm) |
| Wash | 0-5 | 0.5% Acidic Active Oxygen Use | 3.5 | 710.17 |
| #1 | | Solution | | |
| | 5 | 0.2% Alkaline Override Use | 11.4 | 754.82 |
| | | Solution | | |
| | 10-30 | Activator Complex (0.04% KI, | 11.5 | 177.66 |
| | | 0.09% Mo) | | |

Rinse

| | | | | |
|---|---|---|---|---|
| Wash | 0-5 | 0.5% Acidic Active Oxygen Use | 3.4 | 799 |
| #2 | | Solution | | |
| | 5 | 0.2% Alkaline Override Use | 11.2 | 665.99 |
| | | Solution | | |
| | 10-30 | Activator Complex (0.04% KI, | 11.5 | 310.67 |
| | | 0.09% Mo) | | |

Rinse

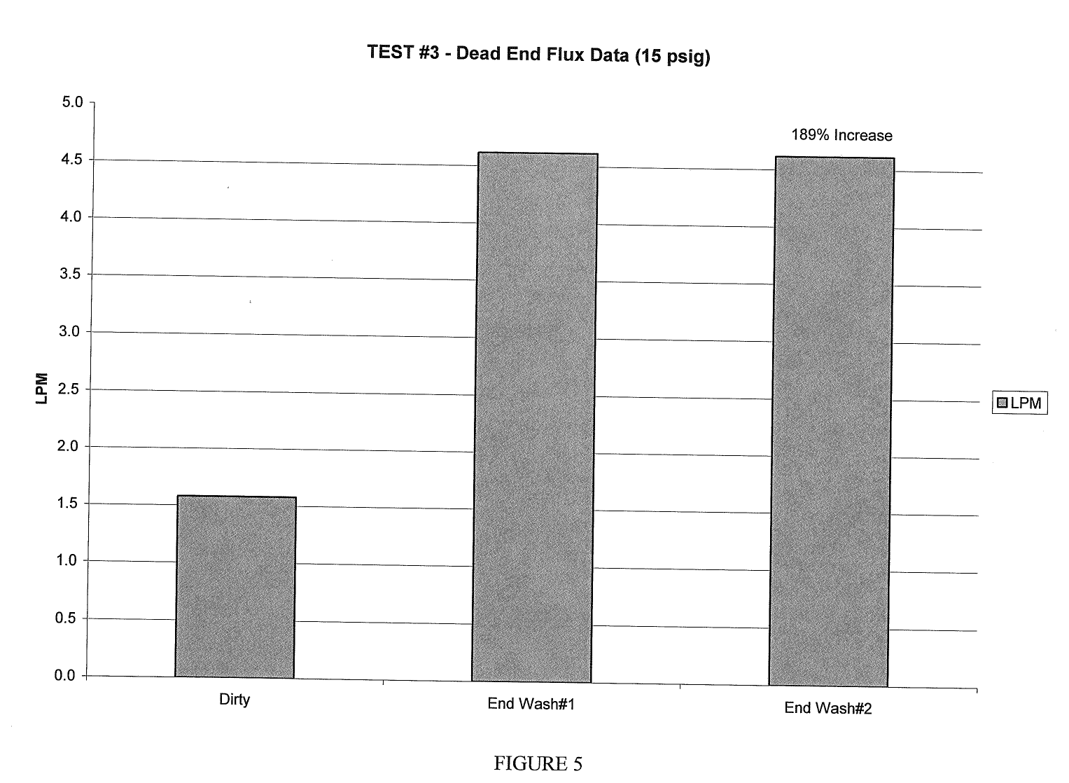

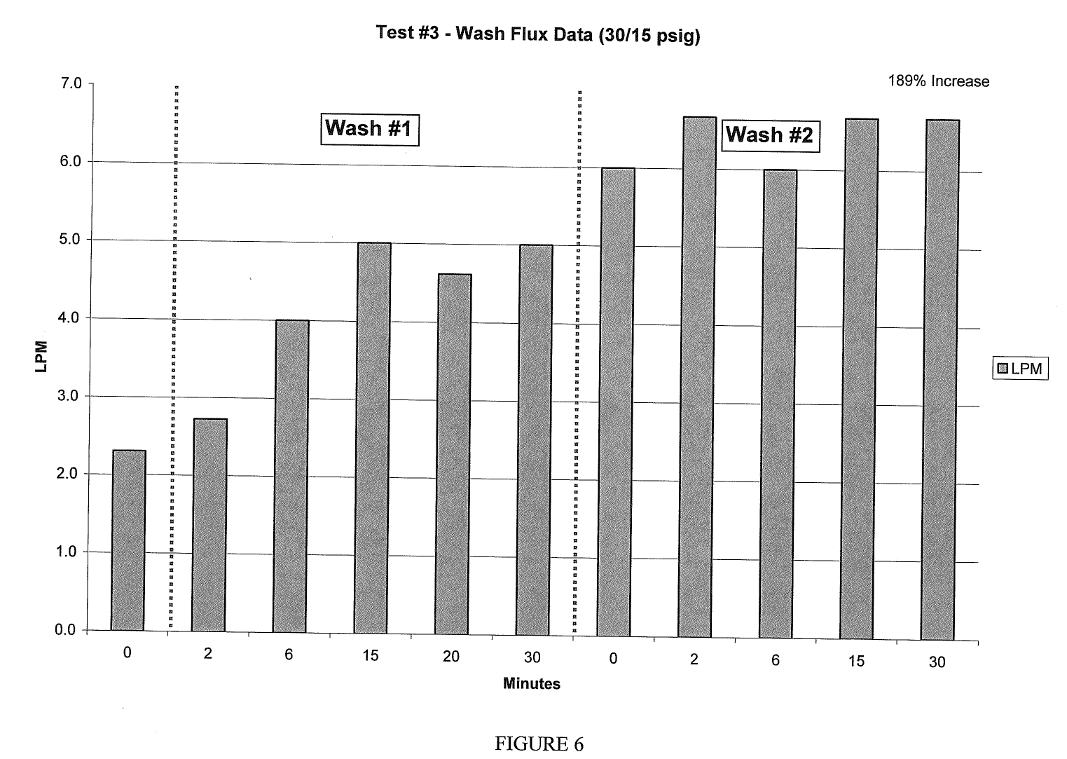

FIG. 5 graphically depicts the dead end flux data at the end of washes #I and #2 compared to the dead end flux data for the dirty membrane. As can be seen from this figure, there was a 189% increase in the flow through the membrane by the end of wash #2. FIG. 6 graphically depicts the wash flux data over the course of wash #1 and wash #2. As can be seen in this figure, the flow through the membrane increased over time throughout each wash.

As can be seen in Table 3, the amount of oxygen available decreases over the course of each wash indicating that adequate activation had been achieved.

### Example 2

### Peroxide Activation at Reduced Temperatures

A series of different activator complexes were tested within the temperature and pH constraints dictated by membrane tolerance limitations. Polymeric membranes have limited tolerance to temperature and pH. These compatibility limitations prevent the use of temperatures greater than about 130° F., and pH greater than about 11.2 and lower than about 1.8 for cleaning systems.

The tests described below were run according to the following protocol. Laboratory grade DI water with no additional soils or other cleaning agents other than NaOH and various activator complexes were tested. The use test solutions were heated to 115° F. in a water bath. Individual timers were started once the test chemistry was added to the preheated DI water in each beaker. Active oxygen was measured by standard iodometric titrations of the heated use solutions at various intervals throughout the test period. The active oxygen was plotted against the exact time of the reading to compare relative degradation differences between the different activator complexes tested.

Test 1

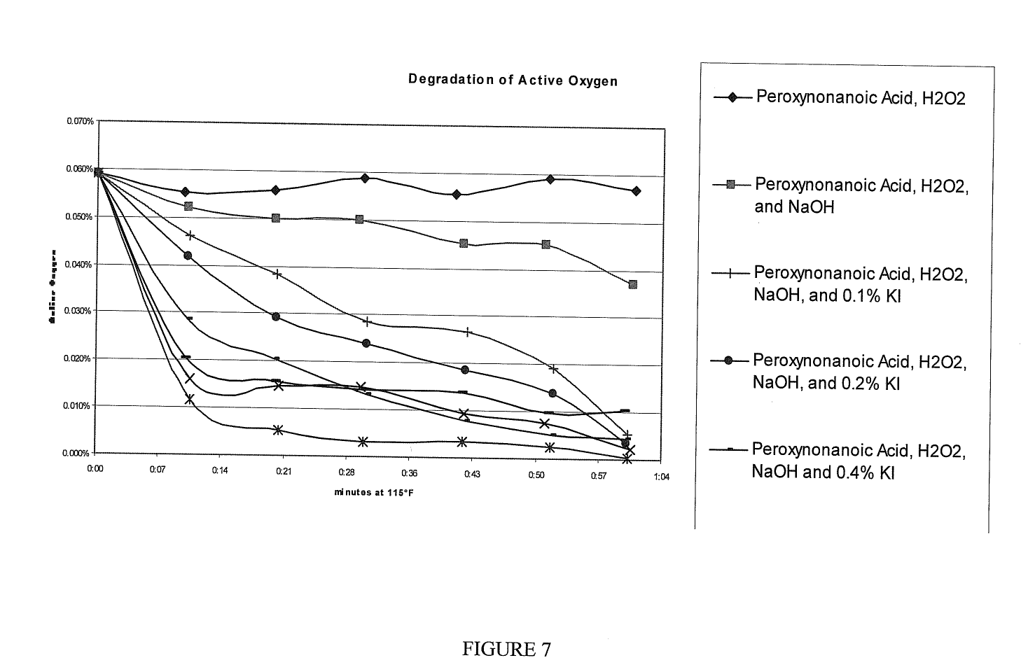

Molybdate (from ammonium molybdate) was compared to potassium iodide (KI) at varying levels and in combination with each other to determine which activator complex, or mixture thereof was the most effective. The same acidic active oxygen use solution described above in Example 1 was used. As can be seen in FIG. 7, the acidic active oxygen use solution was stable under the test conditions for at least 1 hour. The addition of 0.1% NaOH did begin to degrade the active oxygen source within the acidic active oxygen use solution. Also, as can be seen in this figure, the addition of KI did increase the degradation rate, and as the amount of KI increased, so did the degradation. A combination of KI and molybdate had the highest rate of degradation. From this figure, it appears that molybdate has a higher reactivity on a weight basis.

Test 2

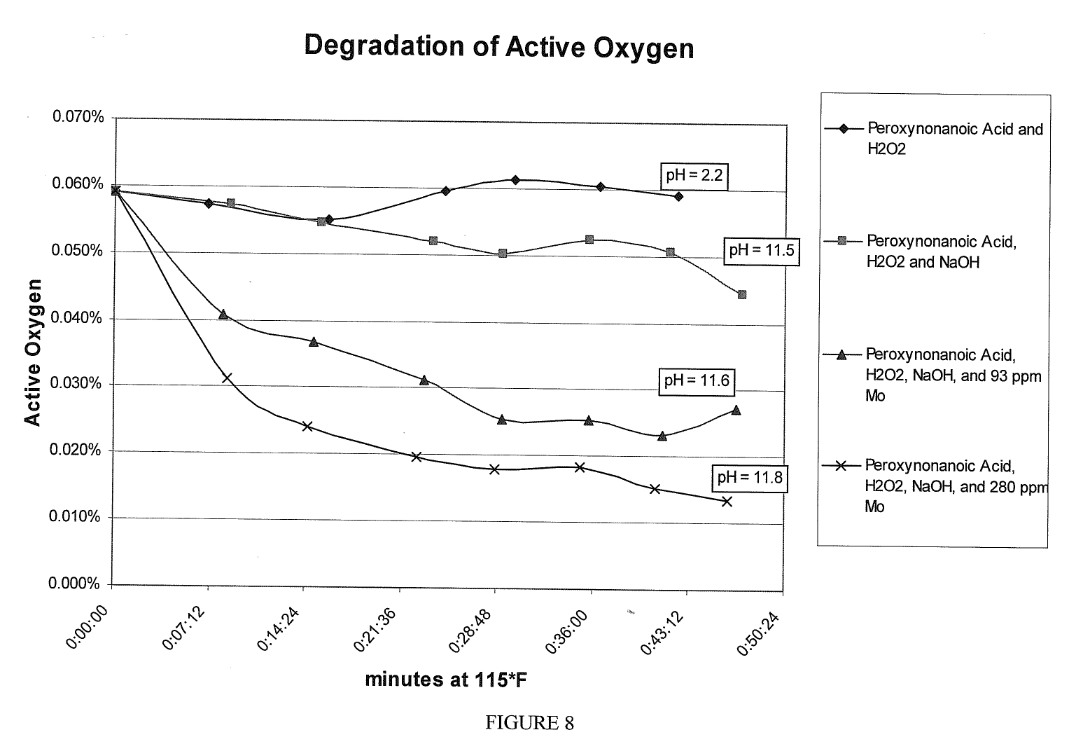

Test 2 was run to evaluate the chemistry when molybdate is used as an activator complex. Sodium molybdate was used for this experiment. The test procedure was identical to that described above, and the same acidic active oxygen use solution described in Example 1 was used. The degradation results can be seen in FIG. 8. As can be seen in this figure, as little as 0.01% (100 ppm) molybdate degraded the active oxygen source by about 50% within 20 minutes. Higher amounts of molybdate resulted in faster degradation rates with diminishing increases around 0.03%. Molybdate concentrations of 0.03%, 0.05% and 0.10% all resulted in active oxygen half-lives of about 7 minutes.

Test 3

Test 3 was run to test lower alkaline solutions to minimize the degradation due to OH—. The test procedure was identical to that described above, however, it was performed at a lower alkalinity. The same acidic active oxygen use solution described above in Example 1 was also used.

It was observed that molybdate degrades the active oxygen source, with a half life of about 7 minutes for all concentrations studied (0.01 to 0.05%). All of the molybdate studies were at a pH of 10.9 which is within the membrane pH limitations. A composition including a reducing agent (sodium metabisulfite) was also tested. The 0.05% bisulfite solution had some effect under these conditions and concentrations.

Overall, these tests (Test 1, Test 2, and Test 3) demonstrated the ability to activate the active oxygen source in the active oxygen use solution using activator complexes, i.e., metal complexes, e.g., Mo and KI, under the temperature and pH limitations of many polymeric membranes.

Test 4

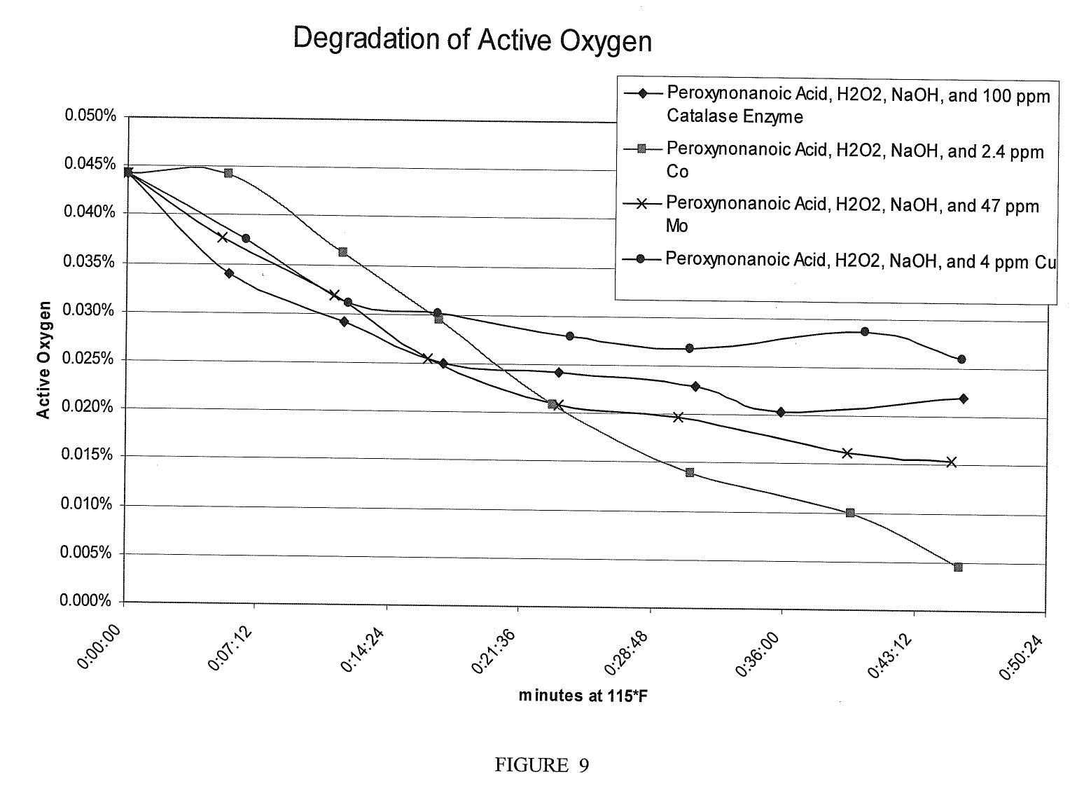

Test 4 was run to evaluate the ability of different activator complexes to activate an active oxygen use solution and generate oxygen gas. The experimental procedure used was the same as described above, however, the acidic active oxygen use solution and the override use solutions were different than those described above. The active oxygen use solution included about 20% hydrogen peroxide, about 3.5% caprylic acid, and about 15% phosphoric acid among other components, e.g., builders. The alkaline override use solution used in this experiment included sodium hydroxide. Copper, cobalt, molybdate, and a catalase were evaluated. FIG. 9 is a graphical depiction of the degradation of active oxygen during this test.

As can be seen in FIG. 9, each of the activator complexes tested activated the active oxygen use solution, and generated oxygen gas, at 115° F. The test solution with 2.4 ppm cobalt as an activator complex had the most degradation of active oxygen over the course of the test, i.e., generated the most gas. Further, the cobalt solution degraded the fastest.

Test 5

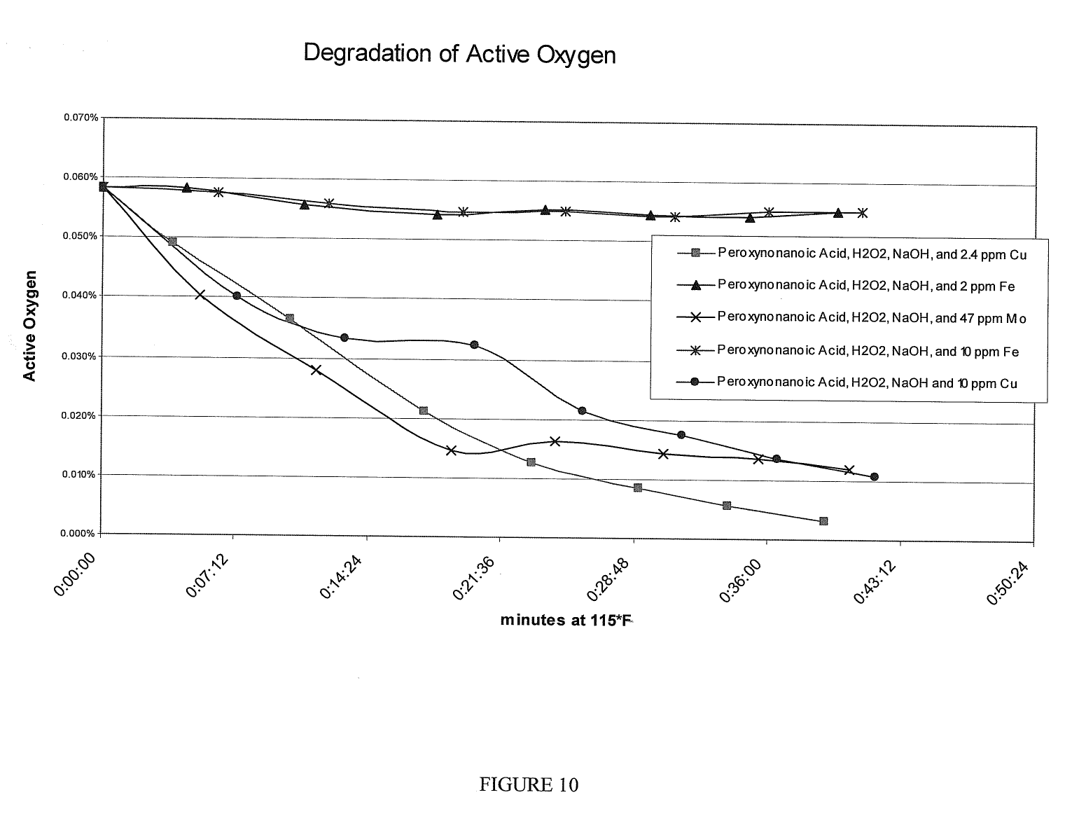

Test 5 was run to evaluate the ability of different activator complexes to activate an active oxygen use solution and generate gas at an alkaline pH, i.e., pH of about 10.9. The test procedure was identical to that described above, and the same acidic active oxygen use solution described above in Example 1 was used. Cobalt, iron, molybdate, and copper were evaluated. FIG. 10 is a graphical depiction of the degradation of active oxygen during this test.

As can be seen in this figure, at this elevated pH, even at 115° F., iron did not activate the active oxygen use solution. That is, the two solutions containing iron as an activator complex (tested at 2 ppm and 10 ppm) did not degrade the active oxygen content of the active oxygen use solutions over the course of the experiment.

Test 6

Test 6 was run to evaluate the effect temperature has on the activation complexes ability to generate oxygen when in contact with an active oxygen use solution. The test procedure was identical to that described above, however, the use test solutions were heated to different temperatures in a water bath. Also, the acidic active oxygen use solutions and the alkaline override use solution were identical to those used in Test 4. The amount of degradation of active oxygen was measured at 70° F., 100° F., 125° F., and 150° F.

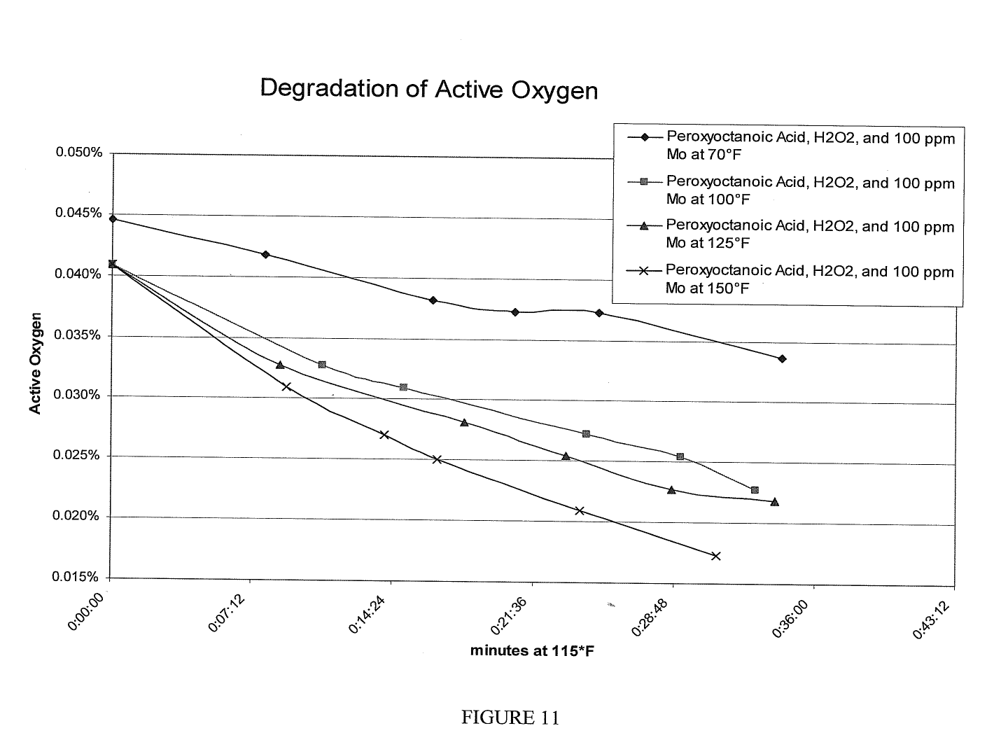

FIG. 11 graphically depicts the results of this test. As can be seen in this figure, even in the presence of a strong activator (Mo), lower temperatures yielded a lower activation potential, i.e., less degradation of active oxygen in solution. Conversely, higher temperatures not suitable for use on certain surfaces, e.g., membranes, lead to a very rapid degradation of active oxygen in solution.

Test 7

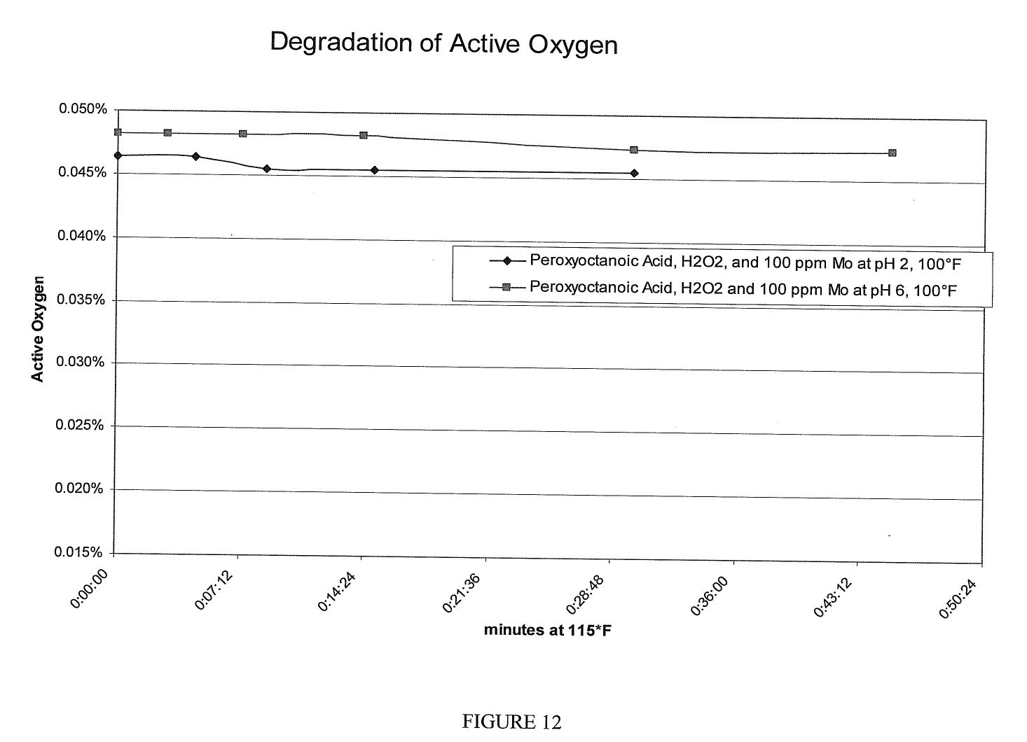

Test 7 was run to evaluate the ability of an activator complex including molybdate to activate an active oxygen use solution at varying levels of pH. The test procedure was identical to that described above. One test solution however was at pH 2 and the other was at pH 6. FIG. 12 shows the results of this test.

As can be seen in this figure, there was minimal activation, i.e., degradation of active oxygen, on the acid side. Thus, some alkalinity is necessary to fully activate the active oxygen use solution using an activator complex of the present invention.

Test 8

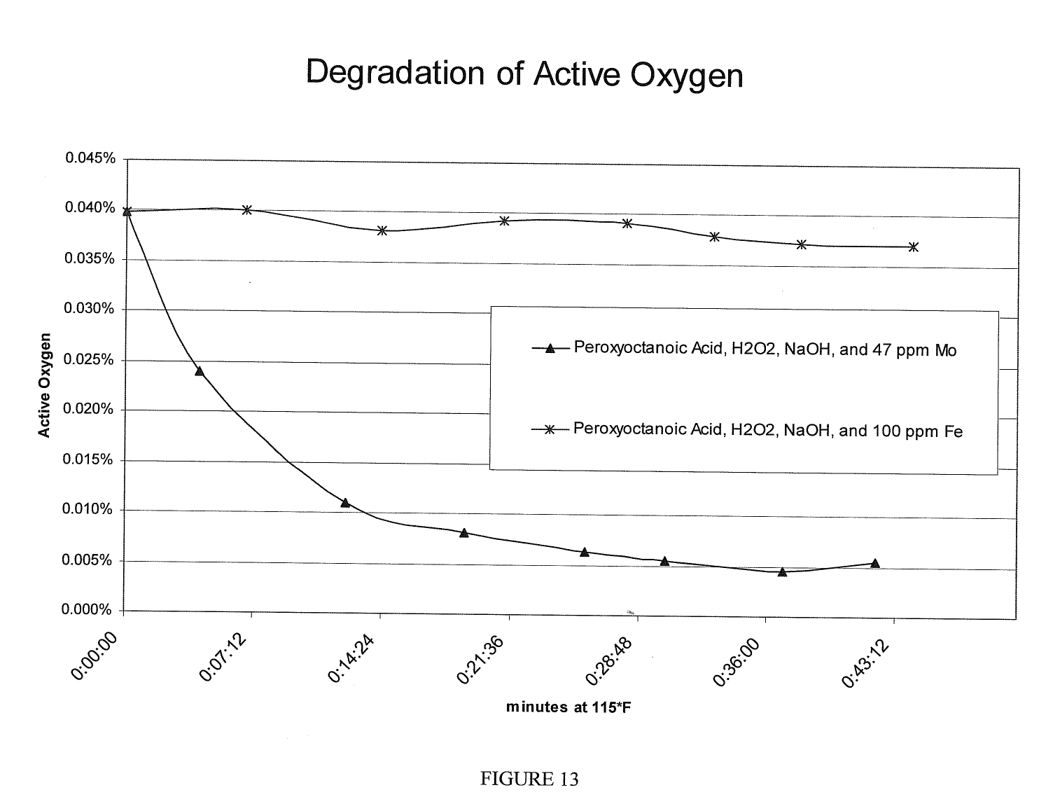

Test 8 was run to compare the ability of iron and molybdate to act as activator complexes. The experimental procedure used was the same as described above, however, the acidic active oxygen use solution and the override use solutions were different than those described above. The active oxygen use solution included about 20% hydrogen peroxide, about 3.5% caprylic acid, and about 15% phosphoric acid among other components, e.g., builders. The alkaline override use solution used in this experiment included sodium hydroxide. FIG. 13 graphically depicts the results of this test. As can be seen in this figure, under identical test conditions, the molybdate works as a much stronger activator complex than the iron. It should be noted that more than twice as much iron was used than molybdate for this experiment. However, as shown in FIG. 13, the iron complex led to less than 0.005% difference in the amount of oxygen available between the start of the test and the end of the test. The molybdate complex however, reduced the amount of active oxygen present by almost 0.035%.

### Example 3

### Comparison Cleaning Test

A cleaning test comparing the use of 50 ppm iron and 50 ppm molybdate as activator complexes at different pHs was performed. Stainless steel coupons were soiled with a solution of whey protein isolate, butter, sodium casinate, whole milk powder, and water. The solution was heated to 125° F. over 10 minutes with an overhead mixer. The soil solution was then cooled and the solution was applied to the stainless steel coupons. The coupons were placed in a 100° F. oven for 2 hours. The heated coupons were removed and allowed to sit at room temperature overnight to dehydrate. The weight of the soiled coupons was measured using an analytical balance.

The cleaning was performed by placing a soiled stainless steel coupon at an angle in a 115° F. solution of a cleaning solution and mixed for 30 minutes. After 30 minutes, the coupons were removed from the cleaning solution and allowed to dry in a 100° F. oven overnight. The panels were removed the following day, cooled, and the weight was recorded. The percent soil removed was the measure for comparing the cleaning abilities of the different cleaning solutions. Pictures of the solutions were also taken at the start and end of the analysis to record the cleaning solution quality.

Four cleaning solutions were tested. Table 4 describes the four cleaning solutions used. Sodium hydroxide was used adjust the pH to about 10 for Solutions 2 and 4, and phosphoric acid was used to adjust the pH to about 2 for Solutions 1 and 3.

TABLE 4

| | |
|---|---|
| Solution 1 | 0.5% Active Oxygen Use Solution, 50 ppm Fe, pH 2 |
| Solution 2 | 0.5% Active Oxygen Use Solution, 50 ppm Fe, pH 10 |
| Solution 3 | 0.5% Active Oxygen Use Solution, 50 ppm Mo, pH 2 |
| Solution 4 | 0.5% Active Oxygen Use Solution, 50 ppm Mo, pH 10 |

The active oxygen use solution used in this test included about 20% hydrogen peroxide, about 3.5% caprylic acid, about 15% phosphoric acid, as well as additional components, e.g., builders.

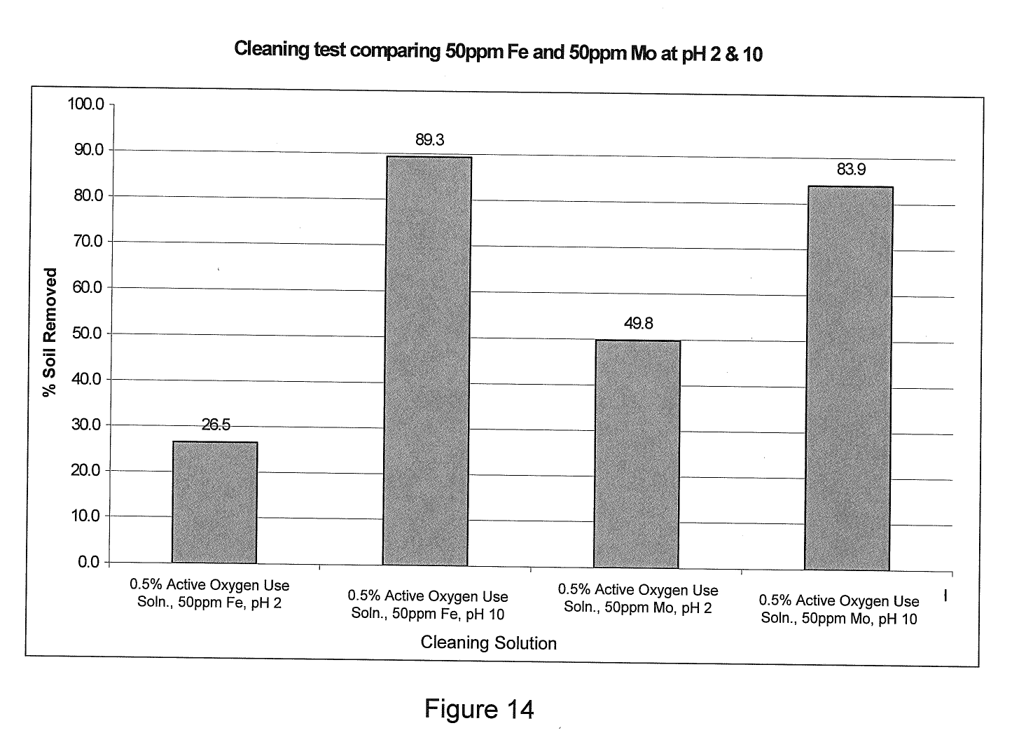

FIG. 14 graphically depicts the percent soil removed using the different cleaning solutions described above. As can be seen in this figure, at pH 2, the cleaning solution that included molybdate as an activator complex had an increased cleaning effect, i.e., a higher percent soil removal rate. At pH 10, both the iron and molybdate activator complexes resulted in above 80% soil removal. However, at this increased pH, the cleaning solution containing the iron as an activator complex was very cloudy, and orange/rust in color. Also, it was observed that the iron precipitated out of solution. Although this precipitation was not problematic for cleaning the surface of a stainless steel coupon, it would not be feasible to use an iron solution at this pH to clean a membrane. Further, many membrane suppliers limit the amount of iron in cleaning solutions to less than 0.05 ppm.

### Example 3

### Food Soil Removal Test

The cleaning effects using the methods of the present invention were evaluated using a food soil removal test. 3×3″ square vinyl coupons were used. A food soil including margarine and powdered milk was applied using a paint brush to the rough-textured side of the coupon. 3.0 g of soil was applied, and allowed to dry overnight. All experiments were conducted at room temperature.

Test1

Two coupons soiled as described above were submerged in separate beakers with 500 g of a 5.0% acidic active oxygen use solution including an active oxygen source including about 75 wt % H₂O₂, among other ingredients. Each coupon was allowed to soak for 15 minutes. 7.5 g of KOH (45%) was added to each beaker. To only one beaker, 1.25 g of a 2000 ppm CuSO₄ solution was added immediately after addition of the KOH (45%) (effectively adding about 5 ppm CuSO₄). The coupons were allowed to soak for an additional 30 minutes.

The coupons were compared visually against an un-treated tile (i.e., a soiled tile, with no treatment). The coupon treated with 5 ppm CuSO₄ appeared the cleanest with most of the soil removed. The coupon treated without 5 ppm CuSO₄ showed good results with over 50% of the soil removed. These results indicate that the addition of CuSO₄ as an activation complex showed beneficial cleaning results.

The cleaning effects from Test 1 were also demonstrated by the appearances of the respective test solutions after the tests. The test solution with the Cu activation demonstrated a head of foam with soil both suspended within the liquid, as well as within the foam. Without wishing to be bound by any particular theory, it is thought that the foam was due to the bubbling action due to the generation of oxygen from the active oxygen source in the acidic active oxygen use solution once contacted with activator complex, e.g., CuSO₄.

Test 2

Two coupons soiled as described above were submerged in separate beakers with 500 g of a 2.5% acidic active oxygen use solution including an active oxygen source including about 75 wt % H₂O₂, among other ingredients. Each coupon was allowed to soak for 15 minutes. 7.5 g of KOH (45%) was added to each beaker, creating a 1.5% KOH (45%)/ 2.5% acidic active oxygen use solution composition. To only one beaker, 5.0 g of a 500 ppm CuSO₄ solution was added immediately after addition of the KOH (45%), effectively adding about 5 ppm CuSO₄ to the solution. The coupons were allowed to soak an additional 30 minutes with the added KOH/CuSO₄. Two control coupons were tested in alkalinity only, one in a 1.5% KOH (45%) solution, and one in a 3.0% KOH (45%) solution. They were allowed to soak for 45 minutes.

The coupon treated with 5 ppm CuSO₄ appeared the cleanest with most of the soil removed, followed by the coupon treated with 2.5% acidic active oxygen use solution with 1.5% KOH (45%). The control coupons treated with only alkalinity showed no soil removal.

Overall, the solutions in Test 1, i.e., those with higher concentrations of acidic active oxygen use solution, removed more soil than those in Test 2. It is also important to note that in Test 1, the combination of 5% acidic active oxygen use solution and 1.5% KOH (45%) resulted in a pH of about 11, while in Test 2 the combination of 2.5% acidic active oxygen use solution and 1.5% KOH (45%) resulted in a pH of 12. The two controls of 1.5% KOH (45%) solution, and one in a 3.0% KOH (45%) resulted in even higher pHs. However, Test 1 at the lowest pH showed the most soil removal. Further, it appears that at very low levels, an activator complex including Cu effectively and rigorously activates the active oxygen source in the acidic active oxygen use solution at room temperature, and relatively low pH.

### Example 4

### Polymerized Corn Oil Removal Test

Three different acidic active oxygen use solutions (Solutions 1, 2, and 3) were tested on polymerized grease plates. Solution 1 included 65 wt % H₂O₂ as an active oxygen source, and octanoic acid as an additional acidic component (among other ingredients). Solution 2 included 65 wt % H₂O₂ as an active oxygen source, and pelargonic acid as an additional acidic component (among other ingredients). Solution 3 included 65 wt % H₂O₂ as an active oxygen source, and isononanoic acid as an additional acidic component (among other ingredients). The additional ingredients in each acidic active oxygen use solution were identical, i.e., the acids listed above were the only varying ingredients in the three solutions. An additional acidic active oxygen use solution (Solution 5) was used in some tests. Solution 5 included about 75% of H₂O₂ as an active oxygen source, and octanoic acid as an additional acidic component (among other ingredients).

The grease plates were tested in two ways, a one-step method, and a two-step method. A one-step method was performed by applying two or three drops of a 5% formula of either Solution 1, 2, 3, or 5 to the polymerized grease coating, followed immediately by adding an equal amount of 4% KOH(45%) on top of the Solution drops. In some tests, varying amounts of Mn was used as an activator complex.

A two-step method was performed by applying two or three drops of a 5% formula of either Solution 1, 2, 3 or 5 to the polymerized grease coating. The Solution applied was allowed to soak in for 15 minutes before an equal amount of 4% KOH(45%) was added on top of the Solution drops. The resulting pH of a 1:1 mixture of 5% Solution 1 and 4% KOH(45%) was 12.15.

It was discovered that the results of these tests were dependent upon the extent of polymerization (affected by the temperature of cooking, and time allowed to cook the corn oil), and the thickness of polymerized grease on the plate (amount of corn oil applied before cooking). When Solutions 1-3 were tested on coatings with relatively consistent degrees of polymerization and soil thickness, it was observed that a two-step method provides better results than a one-step method, and that the two-step method with Solutions 1-3 provided better results than alkalinity alone (Oust 4% KOH(45%)). Table 4 summarizes the results observed.

TABLE 4
Results of Polymerized Corn Oil Removal Test

| Test | | |
|---|---|---|
| Number | Solution applied and experimental method | Results |
| 1 | a. 2 drops of 5% Solution 1 added onto soiled | No Corn Soil Removed |
| | plate. | |
| | b. Immediately added 2 drops (1% MnSO₄•7H₂O/ | |
| | 4% KOH(45%)) solution on top of Solution 1 | |
| | drops. | |
| 2 | a. 2 drops of 5% Solution 1 added onto soiled | After one minute reaction |
| | plate. Allowed 15 minute soak time. | time with Solution 1 and the |
| | b. 2 drops of 500 ppm MnSO₄•7H₂O/4% | alkaline solution, the soil |
| | KOH(45%) solution added on top of Solution 1 | wrinkled and shriveled with |
| | drops. | the touch of a plastic pipette. |
| | c. 2 drops of 500 ppm MnSO₄•7H₂O/4% | The control (2 drops 500 ppm |
| | KOH(45%)) solution added onto a different area | MnSO₄•7H₂O/4% |
| | of the soiled plate, as a control. | KOH(45%), and no Solution |
| | | 1), showed no darkening or |
| | | removal of the soil. |
| 3 | a. 2 drops of 5% Solution 1 added onto soiled | The soil fractured in 3 |
| | plate. Allowed 15 minute soak time. | minutes. |
| | b. 2 drops of 48 ppm MnSO₄•7H₂O/4% | The 48 ppm MnSO₄•7H₂O/ |
| | KOH(45%) solution added on top of the Solution 1 | 4% KOH(45%) solution was |
| | drops. | not uniform, dark clumps had |
| | | precipitated out of solution. |
| | | The supernatant was used in |
| | | the test. A 50/50 mixture of |
| | | 5% Solution 1 and 48 ppm |
| | | MnSO₄•7H₂O/4% |
| | | KOH(45%)) |
| | | yields a pH = 12.15. |
| 4 | a. 2 drops of 5% Solution 1 added onto soiled | No darkening or removal of |
| | plate. Allowed 15 minute soak time. | soil was noted. |
| | b. 2 drops of 53 ppm MnSO₄•7H₂O in water (no | |
| | alkalinity), on top of the Solution 1 drops. | |
| 5 | a. 2 drops of 5% Solution 1 added onto soiled | No darkening or removal of |
| | plate. Allowed 15 minute soak time. | soil was noted. |
| | b. 2 drops of 500 ppm MnSO₄•7H₂O/5% MEA | The 500 ppm MnSO4•7H2O/ |
| | solution on top of the Solution 1 drops. | 5% MEA solution was not a |
| | | uniform solution. |
| | | The final mixture yielded a |
| | | pH = 10.78. |
| 6 | a. 2 drops of 5% Solution 1 added onto soiled | No darkening or removal of |
| | plate. Allowed 15 minute soak time. | soil was noted. |
| | b. 2 drops of 500 ppm MnSO₄•7H₂O/2.33% | The (500 ppm MnSO₄•7H₂O/ |
| | Na₂CO₃ solution on top of the Solution 1 drops. | 2.33% Na₂CO₃) solution was |
| | | not uniform. |
| | | The final mixture yielded a |
| | | pH = 10.26. |
| 7 | a. 2 drops of 5% Solution 1 added onto soiled | Soil fractured in 6 minutes. |
| | plate. Allowed 15 minute soak time. | No precipitate noticed in |
| | b. 2 drops of 10 ppm CuSO4/4% KOH(45%)/1% | laced with 10 ppm CuSO4. |
| | Versene 100 solution added on top of Solution 1 | |
| | drops | |
| 8 | a. 2 drops of 5% Solution 1 added onto soiled | Soil fractured in 6 minutes. |
| | plate. Allowed 15 minute soak time. | No precipitate noticed in |
| | b. 2 drops of 50 ppm CuSO₄/4% KOH(45%)/1% | solution laced with 50 ppm |
| | Versene 100 solution added on top of Solution 1 | CuSO₄ |
| | drops. | |
| 9 | a. 2 drops of 5% Solution 1 added onto soiled | Soil did NOT fracture on its |
| | plate. Allowed 15 minute soak time. | own. After scraping with a |
| | b. 2 drops of 50 ppm CuSO₄/4% KOH(45%) | plastic pipette, fracture |
| | solution added on top of Solution 1 drops. | occurred. |
| | | Precipitate noted in 50 ppm |
| | | CuSO₄/4% KOH(45%) |
| | | solution after sitting one day |
| | | at RT. |
| 10 | a. 2 drops of 5% Solution 5 added onto soiled | Soil did NOT fracture on its |
| | plate. | own. Some bubbling could |
| | b. Immediately add 2 drops of 10 ppm CuSO4/ | be seen, but no darkening of |
| | 3% KOH(45%) solution on top of Solution 5 | the soil occurred. |
| | drops. | |
| 11 | a. 2 drops of 5% Solution 5 added onto soiled | Soil did NOT fracture on its |
| | plate. Allowed 15 minute soak time. | own. At t = 11 minutes with |
| | b. 2 drops of 10 ppm CuSO₄/3% KOH(45%) | alkalinity added, the soil was |
| | solution on top of Solution 5 drops. | still not penetrable with a |
| | | plastic pipette. |

Overall, the burnt-on, polymerized corn oil represents one of the toughest soils to remove because it is a cross-linked polymer network/sheet. Usually compositions with high levels of NaOH or KOH are required to effectively dissolve and remove this soil. The test results discussed above indicate that use of an acidic active oxygen use solution, followed by an alkaline override to neutralize the acidic active oxygen use solution is quite often as good or even better than an alkaline override use solution (where the pH is higher) alone. Furthermore, the use of an activation complex including a low level of Cu and Mn significantly enhances the removal of tough soil when used with an acidic active oxygen use solution including an active oxygen source, e.g., hydrogen peroxide.

### Other Embodiments

It is to be understood that while the invention has been described in conjunction with the detailed description thereof, the foregoing description is intended to illustrate, and not limit the scope of the invention, which is defined by the scope of the appended claims. Other aspects, advantages, and modifications are within the scope of the following claims.

In addition, the contents of all patent publications discussed supra are incorporated in their entirety by this reference.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

We claim:

1. A method for removing soil from a membrane comprising:
applying an acidic active oxygen use solution to the membrane for an amount of time sufficient to penetrate the soil on the membrane, said acidic active oxygen use solution comprising an active oxygen source; and
applying an alkaline override solution, wherein the alkaline override solution comprises:
an activator complex; and
a source of alkalinity; and
wherein there is no rinse step between the application of the acidic active oxygen use solution and the application of the alkaline override solution.

2. The method of claim 1, wherein the active oxygen source comprises a peroxygen compound.

3. The method of claim 2, wherein the peroxygen compound comprises hydrogen peroxide.

4. The method of claim 2, wherein the peroxygen compound is selected from the group consisting of peracetic acid, peroctanoic acid, a persulphate, a perborate, a percarbonate and mixtures and derivatives thereof.

5. The method of claim 1, wherein the pH of the acidic active oxygen use solution is about 2.

6. The method of claim 1, wherein the pH of the alkaline override solution is about 12.

7. The method of claim 1, wherein the activator complex comprises a transition metal complex.

8. The method of claim 7, wherein the transition metal is selected from the group consisting of molybdate, manganese, copper, chromium, cobalt, tin and mixtures thereof.

9. The method of claim 7, wherein the transition metal complex is suitable for use on membranes used in the food processing industry.

10. The method of claim 1, wherein the source of alkalinity is selected from the group consisting of basic salts, amines, alkanol amines, carbonates, silicates, and mixtures thereof.

11. The method of claim 1, wherein the acidic active oxygen use solution and the alkaline override solution are applied to the membrane at a temperature less than about 125° F.

12. The method of claim 1, wherein the alkaline override use solution further comprises an additional functional component selected from the group consisting of a membrane compatible surfactant, a builder, a buffer, and combinations thereof.

13. The method of claim 12, wherein the membrane compatible surfactant is selected from the group consisting of linear alkyl benzene sulfonates, alcohol sulfonates, amine oxides, alcohol ethoxylates, alkyl phenol ethoxylates, polyethylene glycol esters, EO/PO block copolymers, and mixtures thereof.

14. The method of claim 12, wherein the builder is selected from the group consisting of HEDP, TKPP, PAA, phosphonobutane carboxylic acid, sodium gluconate, EDTA and mixtures and derivatives thereof.

15. The method of claim 1, wherein the membrane is selected from the group consisting of a MF membrane, a UF membrane, a NF membrane, and a RO membrane.

16. The method of claim 1, wherein the acidic active oxygen use solution further comprises an additional acid selected from the group consisting of phosphoric acid, nitric acid, methane sulfonic acid, sulfuric acid, citric acid, gluconic acid, acid phosphonates, and mixtures thereof.

17. The method of claim 1, wherein the activator complex increases the oxygen released from the acidic active oxygen composition.

18. A method for removing soil from a membrane comprising:
(a) applying an acidic active oxygen use solution to the membrane for an amount of time sufficient to penetrate the soil on the membrane, said acidic active oxygen use solution comprising an active oxygen source;
(b) applying an activator complex; and
(c) applying an alkaline override solution, wherein the alkaline override solution comprises a source of alkalinity;
wherein there is no rinse step between the application of the acidic active oxygen use solution, the application of the activator complex, and the application of the alkaline override solution.

19. The method of claim 18, wherein the active oxygen source comprises a peroxygen compound.

20. The method of claim 19, wherein the peroxygen compound comprises hydrogen peroxide.

21. The method of claim 19, wherein the peroxygen compound is selected from the group consisting of peracetic acid, peroctanoic acid, a persulphate, a perborate, a percarbonate and mixtures and derivatives thereof.

22. The method of claim 18, wherein the pH of the acidic active oxygen use solution is about 2.

23. The method of claim 18, wherein the pH of the alkaline override solution is about 11.

24. The method of claim 18, wherein the activator complex comprises a transition metal complex.

25. The method of claim 24, wherein the transition metal is selected from the group consisting of molybdate, manganese, copper, chromium, iron, cobalt, tin and mixtures thereof.

26. The method of claim 24, wherein the transition metal complex is suitable for use on membranes used in the food processing industry.

27. The method of claim 18, wherein the source of alkalinity is selected from the group consisting of basic salts, amines, alkanol amines, carbonates, silicates, and mixtures thereof.

28. The method of claim 18, wherein the acidic active oxygen use solution and the alkaline override solution are applied to the membrane at a temperature less than about 125° F.

29. The method of claim 18, wherein the alkaline override use solution further comprises an additional functional component selected from the group consisting of a membrane compatible surfactant, a builder, a buffer, and mixtures thereof.

30. The method of claim 29, wherein the membrane compatible surfactant is selected from the group consisting of linear alkyl benzene sulfonates, alcohol sulfonates, amine oxides, alcohol ethoxylates, alkyl phenol ethoxylates, polyethylene glycol esters, EO/PO block copolymers, and mixtures thereof.

31. The method of claim 29, wherein the builder is selected from the group consisting of EDTA, TKPP, PAA, phosphonobutane carboxylic acid, sodium gluconate, HEDP and mixtures and derivatives thereof.

32. The method of claim 18, wherein the membrane is selected from the group consisting of a MF membrane, a UF membrane, a NF membrane, and a RO membrane.

33. The method of claim 18, wherein the acidic active oxygen use solution further comprises an additional acid selected from the group consisting of phosphoric acid, nitric acid, methane sulfonic acid, sulfuric acid, citric acid, gluconic acid, acid phosphonates, and mixtures thereof.

34. The method of claim 18, wherein the activator complex increases the oxygen released from acidic active oxygen composition.

35. A method for removing soil from a membrane comprising:
(a) applying a first acidic active oxygen use solution, a first activator complex, and a first alkaline override use solution to the surface substantially simultaneously, for an amount of time necessary to sufficiently penetrate the soil, said acidic active oxygen use solution comprising an active oxygen source;
(b) rinsing the membrane;
(c) applying a second acidic active oxygen use solution to the membrane for an amount of time sufficient to solubilize the soil on the membrane, said second acidic active oxygen use solution comprising a second active oxygen source;
(d) applying a second activator complex; and
(e) applying a second alkaline override solution, wherein the second alkaline override solution comprises a source of alkalinity;
wherein there is no rinse step between the application of the second acidic active oxygen use solution, the application of the second activator complex, and the application of the second alkaline override solution.

36. A method for removing soil from a membrane comprising:
contacting the membrane with an activated cleaning solution, wherein the activated cleaning solution is prepared by contacting a solid composition comprising an activator complex with an aqueous solution comprising an active oxygen source, wherein dissolution of the solid composition is initiated upon contact with the aqueous solution forming an activated cleaning solution.

37. A method for removing soil from a membrane comprising:
(a) contacting a solid activator complex with an acidic active oxygen use solution comprising an active oxygen source to form an activated cleaning solution,
(b) applying the activated cleaning solution to the surface; and
(c) applying an alkaline override solution to the surface, wherein the alkaline override solution comprises a source of alkalinity;
wherein there is no rinse step between the application of the activated cleaning solution, and the application of the alkaline override solution.
